(19) United States
(12) Patent Application Publication
(10) Pub. No.: US 2026/0289134 A1
(43) Pub. Date: Sep. 24, 2026

(54) SYSTEM

(71) Applicant: SoftBank Group Corp., Tokyo (JP)

(72) Inventor: Tatsuya WATANABE, Tokyo (JP)

(73) Assignee: SoftBank Group Corp., Tokyo (JP)

(21) Appl. No.: 19/561,648

(22) Filed: Mar. 10, 2026

(30) Foreign Application Priority Data
Mar. 19, 2025 (JP) 2025-044465

(51) Int. Cl. G06F 40/30; G06F 40/284; G06N 3/0475

(52) U.S. Cl. CPC G06F 40/30; G06F 40/284; G06N 3/0475

(57) ABSTRACT

A system includes a processor that is configured to obtain a news article body, generate, based on the obtained news article body, a prompt for instructing a generative AI model to search literature information on an information network and to confirm a match with a primary information source, input the generated prompt to the generative AI model, and evaluate a degree of match with the primary information source based on an output of the generative AI model.

### CROSS-REFERENCE TO RELATED APPLICATION

This application is based on and claims priority under 35 USC 119 from Japanese Patent Application No. 2025-044465 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for assessing the reliability of news articles on information networks rely heavily on manual fact-checking, heuristic keyword checks, or superficial source verification. Such approaches are time-consuming, lack scalability, and often fail to rigorously compare the detailed factual content of an article against primary information sources. In particular, existing systems typically do not utilize generative AI models in a structured manner to (i) prompt systematic searches of literature information across the network, (ii) evaluate a degree of match between article content and primary information sources, and (iii) compute a quantitative reliability score for the article based on both AI-derived match information and concrete search results from publicly available information sources. As a result, users have insufficient tools to automatically and objectively evaluate the trustworthiness of news articles distributed via information networks, leading to the rapid spread of misinformation or low-reliability content.

### SUMMARY

In order to solve the foregoing problem, according to one aspect of the present invention, there is provided a system comprising a processor, wherein the processor is configured to obtain a news article body, generate, based on the obtained news article body, a prompt for instructing a generative AI model to search literature information on an information network and to confirm a match with a primary information source, input the generated prompt to the generative AI model, and evaluate a degree of match with the primary information source based on an output of the generative AI model. The processor is further configured to search and compare facts or data included in the news article from publicly available information sources on the information network, and to calculate a reliability score of the news article based on match-degree information received from the generative AI model and search results obtained from the publicly available information sources, and transmit an evaluation result including the reliability score to a terminal of a user. By automatically integrating generative AI-based match evaluation with concrete searches of publicly available information sources, the system enables objective and scalable assessment of the reliability of news articles.

The term “news article body” refers to text content of a news article, including sentences, paragraphs, and associated factual statements that describe events, data, opinions, or explanations, but excluding external metadata such as URL, author profile pages, or separate comment threads.

The term “information network” refers to a communication network such as the Internet or an intranet, through which literature information, publicly available information sources, and other digital documents can be accessed via wired or wireless communication.

The term “literature information” refers to information contained in documents distributed on the information network, including but not limited to academic papers, technical reports, official publications, white papers, statistical documents, and structured datasets.

The term “primary information source” refers to an original or authoritative source of information relating to a fact or data item described in the news article body, such as an original research paper, an official government or institutional publication, or an original database that first reports the relevant information.

The term “prompt” refers to data, including a text string or structured input, generated based on the news article body and supplied to the generative AI model to instruct the generative AI model to perform at least searching of literature information and confirming a match with a primary information source.

The term “generative AI model” refers to a machine learning model, such as a large language model or similar neural network, that generates at least text or structured outputs in response to a prompt, and that is capable of processing natural language instructions relating to searching literature information and evaluating a degree of match.

The term “degree of match” refers to quantitative or qualitative information indicating how closely content of the news article body corresponds to content of a primary information source, and may be expressed, for example, as a score, probability, similarity value, or categorical label.

The term “facts or data” refers to objectively verifiable pieces of information described in the news article body, including events, numerical values, dates, locations, names of entities, and other measurable or confirmable items.

The term “publicly available information sources” refers to information sources that can be accessed by unspecified users via the information network without requiring special authorization, and that include at least official websites, open databases, and online publications made available to the public.

The term “search results” refers to data obtained by executing a search on the information network or in publicly available information sources, and includes at least identifiers, titles, snippets, full texts, or metadata of documents or records determined to be relevant to the facts or data of the news article body.

The term “reliability score” refers to a numerical or categorical value computed by the processor to indicate an overall reliability or trustworthiness level of the news article body, based at least on the degree of match information from the generative AI model and the search results from publicly available information sources.

The term “evaluation result” refers to information generated by the processor that includes at least the reliability score of the news article body and optionally additional explanatory data such as per-fact assessments, associated primary information sources, and summaries of verification.

The term “terminal of a user” refers to an electronic device operated by a user, such as a personal computer, smartphone, tablet, or similar communication device, that is capable of transmitting the news article body to the system and receiving the evaluation result from the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

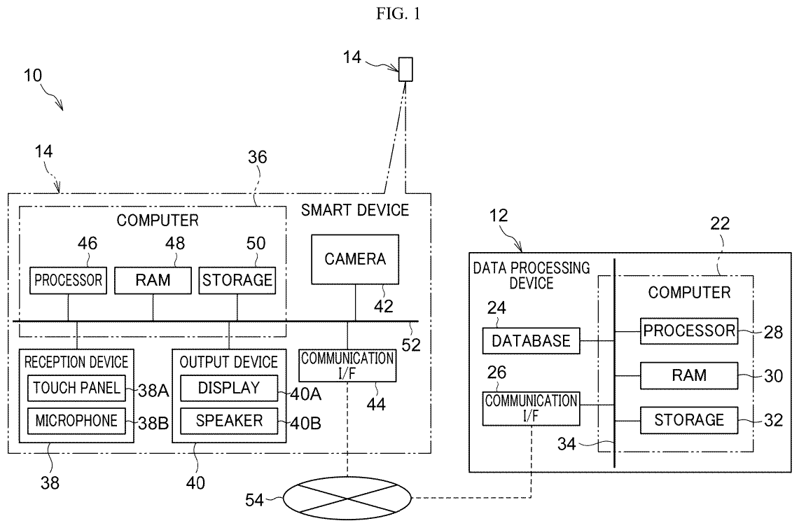

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

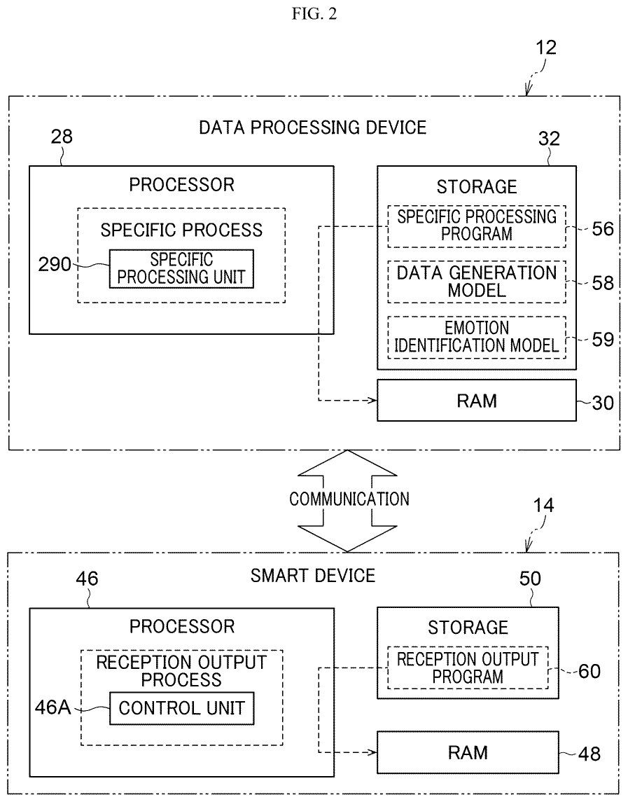

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented techniques for evaluating reliability of news articles rely heavily on manual verification, simple keyword matching, or coarse-grained rule-based checks. These approaches are technically limited in that they (i) do not systematically decompose article content into machine-tractable factual units, (ii) do not efficiently correlate such units with distributed primary-source information available over communication networks, and (iii) do not generate structured, explanation-rich output that downstream software components and user interfaces can reliably consume. As a result, existing systems often suffer from low accuracy, poor scalability, and opaque evaluation behavior from the standpoint of computer system performance and information processing quality.

In particular, when unstructured text of a news article is processed by conventional systems, the processing pipeline typically treats the article as a monolithic string and performs only shallow pattern matching against external resources. This causes a technical bottleneck in information retrieval and similarity computation, because the system cannot optimize query generation or compute similarity at the level of normalized factual statements and associated numerical values. Furthermore, current integrations of generative artificial intelligence models into such pipelines are commonly ad hoc: models are prompted with raw text without structured intermediate data, leading to unstable outputs, increased latency, and difficulty in reproducibly controlling the behavior of the overall computer system.

Therefore, there is a need for a computer-implemented technique that improves the way a processor transforms unstructured article text into structured factual data, generates targeted search queries over an information network, performs vector-based similarity computation between article facts and primary sources, aggregates fact-level support into a machine-usable reliability index, and supplies a generative artificial intelligence model with structured intermediate data via a prompt sentence. Such a technique should improve the technical performance of the system in terms of accuracy, determinism, and computational efficiency of reliability evaluation, and should provide explainable evaluation outputs in a form suitable for further automated processing and presentation to user terminals.

The specific processing by the specific processing unit 290 of the data processing device 12 in Example 1 is realized by the following means.

The present invention provides a server comprising a processor configured to acquire text of a news article; apply natural language processing to the text of the news article to perform lexical segmentation, syntactic analysis, and semantic analysis; extract factual information and numerical information from the text of the news article; generate structured data representing the factual information and the numerical information; generate, based on the structured data, search terms including time information, subject information, and entity information; transmit a search request including the search terms to an external information providing apparatus via an information network; acquire document information of primary-source candidates and text information corresponding to the document information from a public information source; perform feature extraction on the text of the news article and on the text information of the primary-source candidates to generate vector representations; calculate text similarity between each piece of the factual information in the text of the news article and each of the primary-source candidates by using a similarity calculation algorithm; determine a support degree for each piece of the factual information based on the text similarity; calculate a reliability index for the news article as a whole based on the support degree for each piece of the factual information; generate evaluation intermediate data including the reliability index and the support degree for each piece of the factual information; generate a prompt sentence that instructs generation of an explanatory text regarding a degree of correspondence with the primary-source candidates; input the prompt sentence and the evaluation intermediate data to a generative information processing model to acquire reliability evaluation explanation information from the generative information processing model; and generate evaluation result data including the reliability index, the support degree for each piece of the factual information, the document information of the primary-source candidates, and the reliability evaluation explanation information, and transmit the evaluation result data to a user terminal. This enables the computer system to transform unstructured article text into structured factual representations, perform more accurate and efficient similarity-based correlation with primary sources over a communication network, compute a machine-tractable reliability index, and stably control a generative artificial intelligence model via structured prompt sentences, thereby improving the technical performance, scalability, and explainability of news article reliability evaluation.

The term “news article” refers to a text document that describes events, facts, or issues intended for dissemination through a communication medium, and that contains sentences expressing factual information and, optionally, opinions or interpretations.

The term “text of a news article” refers to a character string or sequence of tokens representing the content of a news article, excluding metadata such as formatting codes or transmission headers.

The term “natural language processing” refers to a set of computational techniques executed by a processor for analyzing human language text, including at least one of tokenization, sentence segmentation, part-of-speech tagging, syntactic parsing, named entity recognition, and semantic interpretation.

The term “lexical segmentation” refers to a process in which a processor divides an input character sequence into lexical units such as words, tokens, or symbols that can be individually processed.

The term “syntactic analysis” refers to a process in which a processor determines grammatical relationships between lexical units in a text, such as phrase boundaries, dependency relations, or constituent structures.

The term “semantic analysis” refers to a process in which a processor identifies meaning-related information in a text, including roles of entities, relationships between concepts, and interpretations of numerical expressions or temporal expressions.

The term “factual information” refers to a portion of text that expresses an objectively verifiable statement about an event, entity, state, or relationship, and that can be checked against external information sources.

The term “numerical information” refers to a value or range represented by digits or number words in a text, including percentages, quantities, statistical values, and temporal or spatial magnitudes.

The term “structured data” refers to data represented in a predefined format, such as a record, table, or labeled field set, in which elements including factual information and numerical information are associated with attribute identifiers and can be processed programmatically.

The term “time information” refers to data indicating a point or interval in time, such as a year, date, or period, that is extracted or normalized from a text by a processor.

The term “subject information” refers to data that indicates a main topic or theme of a factual statement, such as an economic indicator, a scientific parameter, or a social event category.

The term “entity information” refers to data that identifies a named or described element involved in a factual statement, including organizations, persons, locations, products, or other identifiable objects.

The term “search terms” refers to one or more words, phrases, or tokens generated by a processor from structured data and used to form a query for retrieving information from an external information source.

The term “information network” refers to an interconnected communication infrastructure, including at least a packet-based network, through which a processor can transmit requests and receive responses in digital form.

The term “external information providing apparatus” refers to a computer system or service accessible via an information network and configured to provide document information or text information in response to a query.

The term “public information source” refers to a collection of data, documents, or records that is accessible, at least under predetermined conditions, to multiple users or systems via an information network.

The term “document information” refers to metadata or descriptive data associated with a document, including at least one of a title, identifier, publication date, author information, or access location.

The term “primary-source candidate” refers to a document or record retrieved from an external information source that is potentially an original or authoritative source for a factual statement contained in a news article.

The term “text information corresponding to the document information” refers to at least a portion of the textual content of a document, such as an abstract, excerpt, or full text, that is associated with given document information.

The term “feature extraction” refers to a process in which a processor converts text or other input data into one or more numerical or symbolic descriptors suitable for similarity calculation or classification.

The term “vector representation” refers to a numerical array or mathematical vector generated from text or structured data, which encodes content or semantic characteristics for use in computational operations such as similarity calculation.

The term “similarity calculation algorithm” refers to a computational method for determining a numerical value that indicates a degree of likeness between two vectors, two texts, or two sets of features, such as cosine similarity or a distance-based metric.

The term “text similarity” refers to a numerical score output by a similarity calculation algorithm that represents a degree of correspondence between two textual contents, for example, between a factual statement in a news article and text information of a primary-source candidate.

The term “support degree” refers to a measure, which may be numerical or categorical, indicating how strongly a primary-source candidate's text supports or contradicts a specific piece of factual information extracted from a news article.

The term “reliability index” refers to a value computed by a processor that summarizes, for an entire news article, an overall level of reliability based on support degrees for multiple pieces of factual information.

The term “evaluation intermediate data” refers to data generated during processing, including at least the reliability index and support degrees for individual pieces of factual information, which is used as input for subsequent computation or explanation generation.

The term “prompt sentence” refers to a text string or sequence of tokens provided to a generative information processing model, which instructs the model regarding a task to be performed or a type of output to be generated.

The term “generative information processing model” refers to a machine-learned model configured to generate text or other outputs in response to an input sequence, including but not limited to a probabilistic language model or a neural network-based generative model.

The term “reliability evaluation explanation information” refers to text or structured data generated by a generative information processing model that explains, at least in part, reasons or context for a reliability index or support degrees associated with a news article.

The term “evaluation result data” refers to data generated by a processor that includes at least a reliability index, support degrees for pieces of factual information, document information of primary-source candidates, and reliability evaluation explanation information, and that is intended for output to a user terminal.

The term “user terminal” refers to an information processing device, such as a client computer or mobile device, through which a user can transmit a news article to a server and receive evaluation result data.

In the following embodiments, a “server” denotes one or more information processing apparatuses including at least one processor, a memory, a non-transitory storage device, and a network interface. A “terminal” denotes a client information processing apparatus operated by a user. A “generative AI model” denotes a generative information processing model implemented as a trained machine learning model executed on the server or on an external computing resource accessible via a network.

### A. Overall Configuration of the System

The server stores program modules in a non-transitory storage device and the server executes the program modules by means of a processor and a memory. The server communicates with one or more terminals via a communication network such as a packet-based network using a network interface.

The server executes a web application framework, such as a generic server-side application environment, and the server exposes an application programming interface (API) that receives a news article text from the terminal. The server includes a natural language processing module, a search query generation module, an external source retrieval module, a vectorization and similarity computation module, a reliability scoring module, and a generative explanation module.

The terminal executes a user interface program such as a web browser or a native application. The terminal displays input fields for a news article text and the terminal transmits the text to the server using a request over a secure communication protocol. The user inputs or selects a news article and the user initiates a reliability evaluation operation via the terminal.

### B. Hardware and Software Components

The server uses a general-purpose processor, such as a multi-core central processing unit, and, in some embodiments, the server additionally uses a graphics processing unit for accelerating matrix operations and neural network inference. The server uses a main memory for storing intermediate data structures and the server uses a non-transitory storage device, such as a solid-state drive, for persisting configuration data, logs, and pre-trained model parameters. The server uses natural language processing software libraries, such as a general-purpose tokenization and parsing library and a statistical or neural named entity recognition library. The server uses a feature extraction and vectorization library, for example a library that implements term frequency-inverse document frequency vectorization and numerical linear algebra operations. The server may use a sentence embedding library that wraps a neural network model for computing dense representations of sentences.

The server accesses one or more external information providing apparatuses via web-based APIs. The external apparatuses may include scholarly literature databases, statistical data repositories, and other public information sources that respond with document information and associated text data in a structured format. The server may also access internal document repositories using a search engine server.

The server accesses a generative AI model via an internal inference engine or via an external model serving API. The generative AI model may be a neural network language model using a transformer architecture. The server stores model parameters in a non-transitory storage device and the server loads the parameters into memory for inference.

### C. Data Structures

The server represents the text of a news article as a sequence of characters and tokens. The server transforms the text into a document object that includes sentence boundaries, token lists, part-of-speech tags, named entity types, and dependency relations. The server stores this document object in memory.

The server represents each extracted fact as a record including at least the following fields: a unique fact identifier, a subject field, a predicate field, an object field, a numerical value field when applicable, a time field, and a source span field indicating character positions in the original article text. The server may extend this record with an importance weight field and an uncertainty field.

The server represents each search query as a record including a query identifier, a list of tokens, a list of facets such as year, topic, and entity type, and a pointer to one or more related fact identifiers. The server represents each primary-source candidate as a record including a document identifier, title text, publication time, source type, and a list of text snippets relevant to specific facts. Each text snippet is stored along with its own identifier and position metadata.

The server represents vector representations as numerical arrays stored in memory. The server associates each vector with a fact identifier or a snippet identifier using mapping tables. The server stores similarity scores in a matrix or table, where each element corresponds to a fact-snippet pair.

The server represents support degrees for each fact as categorical values and numerical scores. For example, the server may assign “strong support,” “partial support,” or “no support” as categorical labels and also store a numeric similarity score in a predefined range. The server represents an overall reliability index as a numeric value normalized to a range, such as 0 to 100.

The server represents evaluation intermediate data as a structured object containing the reliability index, a list of fact records enriched with similarity scores and support labels, and a list of primary-source candidate records with associated contributions to the score. The server represents a prompt sentence and associated context for the generative AI model as a text string, possibly including delimiters and tags that encode structured information.

### D. Natural Language Processing and Fact Extraction

The server loads a pre-trained natural language processing model into memory. This model is trained in advance on a corpus of general-domain or domain-specific text using supervised and unsupervised learning techniques. During training, the model parameters are optimized using a loss function such as cross-entropy error on part-of-speech and entity labels, and the parameters are updated using a gradient-based optimization algorithm such as stochastic gradient descent or an adaptive method. The pre-training procedure uses batches of tokenized sentences and the server adjusts the model weights to minimize classification error.

The server applies this model to the input article text. The server performs lexical segmentation by splitting the character sequence into tokens following predefined rules and learned patterns. The server performs syntactic analysis by computing dependency relations between tokens. The server performs semantic analysis by resolving named entities and by identifying phrases that correspond to quantitative assertions, time expressions, and entity relationships.

The server identifies candidate factual statements using a non-conventional rule set that combines syntactic and semantic criteria. For example, the server selects clauses that contain at least one quantifiable predicate and one named entity of a predetermined category, such as an organization or a geographic region. The server discards clauses that are marked as subjective or hypothetical using lexical cues and dependency patterns. This rule-based filtering is executed as program logic and yields a set of factual information records with associated numerical information when available.

The server normalizes time expressions and numerical values using conversion rules and a temporal parsing module. For example, the server converts text such as “in 2023” to a normalized year value and the server converts percentages such as “3.5%” to a standardized numeric form. The server associates each normalized value with the corresponding fact record.

This combination of deep linguistic analysis and rule-based fact selection enables the server to construct machine-tractable structured data that is more precise than simple keyword extraction, thereby reducing noise in subsequent search and similarity operations and improving accuracy and computational efficiency.

### E. Query Generation and External Retrieval

The server generates search terms from the structured fact records by selecting and combining elements such as normalized year, main subject phrase, and principal entities. The server uses lemmatization modules to reduce words to base forms and the server may remove high-frequency stop words. The server stores the resulting query terms as tokens and phrases in the query record.

The server constructs a request to an external information providing apparatus by embedding the query terms into a request format specified by the external apparatus. The server uses a client library to send the request through a network interface over a communication protocol. The server receives a response that includes document information and associated text fields. The server parses the response and populates primary-source candidate records. The server may perform deduplication by comparing document identifiers or by computing title similarity scores. The server extracts relevant text snippets from the documents by applying keyword matching and simple proximity rules that focus on segments containing the same time expressions or numerical values as in the fact records.

By generating queries from normalized fact structures rather than from entire article text, the server reduces unnecessary network traffic, narrows search results to highly relevant documents, and decreases computation load for later similarity calculations.

### F. Vectorization and Similarity Computation

The server converts each fact text and each source snippet text into vector representations. In one embodiment, the server uses a term frequency-inverse document frequency vectorizer that maps each token into a high-dimensional sparse vector. In another embodiment, the server uses a sentence embedding model based on a neural network. The neural network may be a transformer encoder trained using contrastive learning on pairs of semantically similar and dissimilar sentences. During training, the server minimizes a loss function such as a cosine similarity loss that encourages closer vectors for similar sentences.

The server loads the trained vectorization model into memory and the server computes embeddings by performing matrix multiplications and non-linear transformations on token embeddings. The server may use a graphics processing unit to accelerate these linear algebra operations. The server stores the resulting embeddings as arrays of floating-point numbers. The server computes similarity between fact vectors and snippet vectors using a similarity calculation algorithm such as cosine similarity. The server computes a dot product and a norm for each pair and outputs a similarity score in a normalized range. The server may compute these scores in batches to reduce overhead and improve cache utilization.

The server additionally computes a token-level overlap measure, such as an intersection-over-union score on sets of keywords, and the server combines this value with the vector similarity in a weighted formula. The server stores the final similarity score in a matrix indexed by fact identifier and snippet identifier.

This vector-based handling of text, combined with optimized batch processing and the use of hardware acceleration, improves the technical field of information retrieval by increasing precision and throughput of similarity calculations compared with naive string matching or manual inspection.

### G. Reliability Scoring and Support Degree Assignment

The server assigns support degrees to each fact based on similarity scores. The server defines thresholds and rules in configuration data. For example, the server may define that a similarity score above a first threshold indicates strong support, a score between the first and a lower second threshold indicates partial support, and a score below the second threshold indicates no support. The server may further adjust these decisions using the publication time of the primary-source candidates and the source type.

The server calculates an overall reliability index by aggregating support degrees. The server counts supported, partially supported, and unsupported facts and weights them using importance values stored in fact records. The server computes an index value using a predefined formula that may include normalization by the number of facts and penalty terms for unsupported critical claims.

The server stores evaluation intermediate data including the reliability index and per-fact support information. The server may write this data to a database for auditability and for later comparison across different versions of models and rules. This structured scoring layer creates a deterministic and reproducible link between low-level similarity metrics and high-level reliability assessments, which is beneficial for debugging and optimizing the system.

### H. Generative Explanation Using a Generative AI Model

The server constructs a prompt sentence for a generative AI model by combining textual descriptions with structured intermediate data. The server may format the prompt as a sequence of sentences that describe the task and embed fact summaries, support statuses, and citations to primary sources.

For example, the server may generate a prompt sentence such as:

“You are assisting in evaluating the reliability of a news article. For each factual statement listed below, you are given a support status (strong support, partial support, or no support) and excerpts from primary sources retrieved from public databases. Based on this information, explain why each statement is supported or not, and then provide an overall reliability assessment for the article on a scale from 0 to 100.”

In another example, the server may generate a prompt sentence such as:

“The following facts were extracted from a news article and compared with primary-source documents from public information sources. For each fact, a similarity score and a support category have been computed. Please generate a concise explanation report that describes which facts are strongly supported, which are partially supported, which are not supported, and why, and then summarize the overall reliability of the news article.”

The server inputs this prompt sentence and accompanying structured text to the generative AI model. The server uses a transformer-based language model that includes multiple self-attention layers, feed-forward neural network layers, and positional encoding. The model parameters are trained in advance using large-scale text corpora and fine-tuned using instruction-style datasets where the model learns to produce explanation outputs from structured inputs.

During training, the model minimizes a token-level prediction loss, typically a cross-entropy loss, by comparing predicted tokens with reference tokens. The server updates weights using a gradient-based optimizer and may apply regularization techniques such as dropout. Data augmentation may be used to vary prompt phrasing and to expose the model to diverse patterns.

During inference, the server feeds the prompt into the model, and the model generates tokens step by step. The server controls decoding by using techniques such as beam search, top-k sampling, or nucleus sampling with specified parameters. The server may enforce constraints to avoid overly long responses and to maintain coherence. The server receives generated explanation text and the server may post-process it for formatting and truncation.

By supplying the generative AI model with structured intermediate data instead of raw article text alone, the server reduces ambiguity for the model, improves consistency of output, and reduces processing time because the model does not need to perform complex extraction and matching operations internally. This represents an improvement in how the computing system integrates generative models into a multi-stage pipeline and results in more predictable and technically controlled behavior.

### I. Interaction with the Terminal and Presentation to the User

The terminal receives evaluation result data from the server. The terminal parses the data and the terminal updates graphical user interface elements. The terminal may display the reliability index as a numeric value and as a visual indicator such as a color-coded bar. The terminal lists key facts with their support categories and provides hyperlinks for primary-source documents.

The user observes the evaluation results and the user may expand sections of the interface to view the generative explanation text. The terminal does not perform complex analysis but instead presents processed information from the server. The communication between the server and the terminal uses efficient encoding formats and allows caching, which reduces network load when the user revisits prior evaluations.

### J. Technical Effects and Improvements

The server improves computer technology in several ways. First, by transforming unstructured article text into structured fact records using advanced natural language processing and rule-based filtering, the server reduces the size and complexity of data passed to external retrieval and similarity modules. This leads to reduced memory consumption, fewer network requests, and faster processing.

Second, by applying vectorization and similarity algorithms optimized for dense or sparse representations and by using hardware acceleration where available, the server increases the rate at which it can compute similarity between article facts and primary sources, enabling near real-time evaluation even for long articles and large external corpora.

Third, by aggregating similarity-based support degrees into a reliability index using formal rules, the server produces a machine-tractable metric that can be stored, searched, and compared programmatically, which improves data management and facilitates large-scale monitoring of information quality.

Fourth, by constructing prompt sentences from structured intermediate data and by supplying them to a transformer-based generative AI model, the server improves stability and controllability of generative outputs. The generative AI model is used not as a black box replacing human judgment, but as a controlled component that receives precisely defined features and produces constrained explanatory text. This configuration reduces error rates, prevents hallucination-like outputs, and enables reproducible explanations.

Fifth, the server employs non-conventional rules for fact selection, normalization, and support assignment that are specifically designed to interact with vector-based retrieval and generative explanation modules. These rules differ from manual human fact-checking workflows and from simplistic keyword-based automated systems. The combination of structured intermediates, optimized similarity algorithms, and controlled generative explanation enables improvements in processing speed, accuracy, and reliability of output.

### K. Variations and Alternative Embodiments

The server may, in another embodiment, use different neural network architectures for vectorization, such as convolutional neural networks or recurrent neural networks, or hybrid architectures. The server may adapt the loss function during training, for example by using margin-based ranking losses to emphasize correct ordering of similarity scores.

The server may use different types of similarity calculation algorithms, such as Euclidean distance, Manhattan distance, or learned similarity functions implemented as small neural networks that take two vectors as input and output a similarity score.

The server may adjust thresholds and weighting schemes dynamically based on historical performance and feedback data. For example, the server may use reinforcement learning or automated hyperparameter search to refine the rules that map similarity scores to support categories and to reliability indices.

The server may implement caching of vector representations for frequently evaluated facts or recurrent entities to further reduce computation time. The server may also schedule background processes to pre-index external information sources and to compute embeddings for newly added documents to speed up retrieval.

In another embodiment, the server may deploy multiple generative AI models specialized for different domains, such as economics, health, or technology. The server may select an appropriate model based on the subject information in the fact records and may adjust prompt sentences accordingly. This modular approach allows the system to scale across domains while maintaining technical control over inference behavior.

Through these embodiments and variations, the server, the terminal, and the user cooperate in a system that leverages advanced natural language processing, optimized similarity computation, structured intermediate data, and controlled generative modeling to provide technically improved, efficient, and explainable reliability evaluation of news articles.

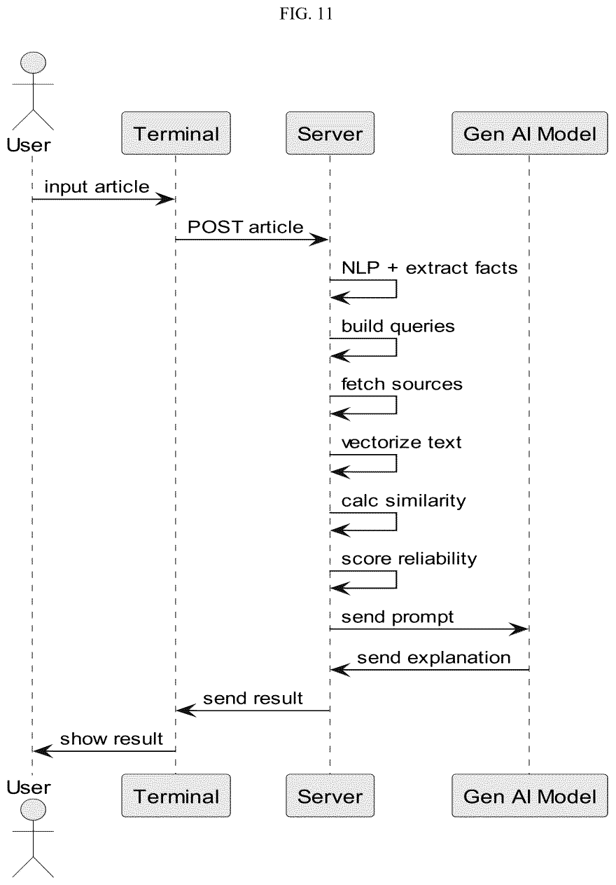

The following describes the processing flow using FIG. 11.

### Step 1

The user prepares a news article on the terminal as plain text. The terminal displays an input field and receives the article text from the user as input. The terminal takes the input text string, wraps it in a data structure such as a JSON object, and transmits the JSON object to the server over a network as an HTTP request. The output of the terminal in this step is a network request containing the article text addressed to the server.

### Step 2

The server receives the HTTP request from the terminal as input. The server parses the request, validates that the JSON structure is correct, and extracts the article text field. The server then stores the article text and associated metadata (such as a timestamp and a request identifier) in memory or persistent storage. The output of the server in this step is a stored article record that includes the raw article text and an internal identifier.

### Step 3

The server uses the stored article text as input for a natural language processing module. The server loads a language processing model into memory and applies lexical segmentation, sentence boundary detection, part-of-speech tagging, and named entity recognition to the article text. The server then analyzes syntactic relations and semantic roles to identify candidate sentences that express factual information and numerical information. The output of the server in this step is a list of extracted fact records, each record including at least a text span, entities, numerical values, and temporal expressions.

### Step 4

The server takes the list of fact records as input and performs normalization and structuring. The server converts textual numerical expressions into standardized numeric values, and the server converts time expressions into normalized date or year fields. The server also standardizes entity names and subject phrases into canonical forms. The server then generates structured data objects for each fact, with fields such as subject, predicate, object, normalized value, and time. The output of the server in this step is a set of structured fact objects ready for query generation.

### Step 5

The server uses the structured fact objects as input to a query generation module. The server selects key elements from each fact (such as normalized year, main subject, and primary entities), applies lemmatization, and removes stop words. The server concatenates the selected tokens into one or more search terms and assembles query strings. The server creates a query record that links each query string to one or more originating fact identifiers. The output of the server in this step is a list of query records, each containing a search term string and metadata for subsequent external retrieval.

### Step 6

The server uses the list of query records as input for external information retrieval. The server sends network requests to one or more external information providing apparatuses, embedding the search term strings as query parameters. The server receives responses including document information and associated text snippets in a structured format. The server parses the responses, maps each returned document to the corresponding query and fact identifiers, and stores primary-source candidate records with fields such as title, publication time, and snippet text. The output of the server in this step is a collection of primary-source candidate records associated with the original facts.

### Step 7

The server takes the article fact texts and the source snippet texts as input to a vectorization module. The server loads a feature extraction model or a sentence embedding model into memory and converts each text input into a numerical vector by applying token embedding, weighting, and aggregation operations. The server may perform matrix multiplications and non-linear transformations to obtain dense or sparse vector representations. The server stores these vectors in memory, indexed by fact identifier and snippet identifier. The output of the server in this step is a set of vector representations corresponding to facts and source snippets.

### Step 8

The server uses the fact vectors and snippet vectors as input to a similarity computation module. The server calculates similarity scores using a similarity calculation algorithm, such as computing the cosine similarity between pairs of vectors. The server optionally computes additional overlap metrics on keyword sets and combines them with the cosine similarity in a weighted formula. The server fills a similarity matrix in which each element corresponds to a fact-snippet pair and the element value is the computed similarity score. The output of the server in this step is a similarity score table that quantifies how closely each fact matches each primary-source snippet.

### Step 9

The server takes the similarity score table as input and assigns support degrees to each fact. The server compares each fact's highest similarity score against predefined thresholds and classifies the fact as strongly supported, partially supported, or not supported. The server may also record the specific primary-source snippet that produced the maximum score. The server stores the support category and the numeric score in the corresponding fact record. The output of the server in this step is an updated list of fact records that include support categories and similarity scores.

### Step 10

The server uses the updated fact records as input to a reliability scoring module. The server counts the number of facts in each support category, applies importance weights stored in the fact records, and computes a reliability index using a numeric formula, such as a weighted average scaled to a 0-100 range. The server then constructs evaluation intermediate data that includes the reliability index, the per-fact support categories, the similarity scores, and references to primary-source candidate records. The output of the server in this step is a reliability index value and a structured evaluation intermediate data object associated with the article.

### Step 11

The server uses the evaluation intermediate data as input to a prompt generation module. The server converts the structured data into a human-readable description and embeds it into a prompt sentence designed for a generative AI model. The server may include lists of facts, their support categories, main similarity scores, and short citations for primary sources. For example, the server may generate a prompt sentence such as: “The following facts were extracted from a news article and compared with primary-source documents. For each fact, a similarity score and a support category have been computed. Please explain why each fact is supported or not and provide an overall reliability assessment.” The output of the server in this step is a prompt sentence and associated context text ready for input to the generative AI model.

### Step 12

The server uses the prompt sentence and context text as input to the generative AI model. The server submits the prompt to a transformer-based language model, which processes the sequence and generates output tokens representing an explanation. The server receives the generated explanation text, parses it if necessary, and may perform post-processing to remove redundant sections or to enforce length limits. The output of the server in this step is reliability evaluation explanation information that describes reasons for support decisions and summarizes the overall reliability of the article.

### Step 13

The server uses the reliability index, the updated fact records, the primary-source candidate records, and the generated explanation text as input to a response construction module. The server assembles evaluation result data including at least the reliability index, the support category for each fact, links or identifiers for primary sources, and the explanatory text from the generative AI model. The server formats this data into a response structure suitable for transmission to the terminal. The output of the server in this step is a response object containing the complete evaluation result.

### Step 14

The server transmits the response object as output to the terminal over the network. The terminal receives the response as input and parses the data structure. The terminal then updates a graphical user interface to display the reliability index, categorized facts, and source references. The terminal also displays the explanatory text generated by the generative AI model. The user views the displayed information on the terminal and may use it to decide how to interpret, share, or further investigate the news article.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented techniques for evaluating the reliability of news content on communication networks suffer from several technical limitations. Typical systems rely on simple rule-based filters, keyword counting, or shallow link analysis between a news article and a limited set of reference sources. Such approaches often operate on unstructured text without extracting explicit assertion units or modeling how individual factual claims relate to multiple heterogeneous information sources, such as scientific literature databases and expert comment repositories. As a result, conventional systems tend to produce coarse, opaque, or unstable reliability indicators that do not adequately reflect the underlying evidentiary support for each claim in an article.

From a computer-technology standpoint, existing architectures usually treat large-scale language models, external document databases, and user interfaces as loosely connected components. The prompt sentences supplied to machine-learned models are often ad hoc and not derived from a structured, machine-generated representation of claims, primary sources, and expert opinions. This leads to inefficient utilization of computing resources, inconsistent inference behavior of generative models, and an inability to systematically map low-level text features to high-level reliability scores. Furthermore, many systems transmit only raw or minimally processed scoring results to terminal devices, without encoding display control information that allows the terminal devices to adaptively emphasize alerts according to computed reliability thresholds. This limits the capability of the overall system to provide timely, machine-driven guidance to users through the user interface.

Accordingly, there is a need for an improved computer-implemented technique that systematically transforms unstructured news article text into structured evaluation target information, constructs formally defined prompt sentences for a generative artificial intelligence model, and integrates the model's structured output into a deterministic scoring and display-control pipeline. Such a technique should enhance the technical functioning of the server by orchestrating natural language processing, external database access, prompt construction, model inference, and threshold-based display control as a coordinated sequence of machine operations. In particular, there is a need for a system that extracts assertion sentences, associates them with primary source candidates and expert opinion information, and automatically generates reliability scores and warning information in a form that can be directly consumed by terminal devices for emphasized, context-aware presentation to users.

The specific processing by the specific processing unit 290 of the data processing device 12 in Application Example 1 is realized by the following means.

The present invention provides a server comprising a processor configured to acquire news article text from a communication network, to perform text normalization and sentence segmentation on the acquired news article text, to analyze the news article text on a word level and a sentence level by natural language processing, to extract entity information and important phrase information based on an analysis result, to generate search terms constituting search queries to document information storage apparatuses on an information network, to acquire document information corresponding to primary source candidates from a plurality of types of document information storage apparatuses on the information network based on the search terms, to extract candidate sentences from the news article text and identify, from the candidate sentences, assertion sentences including factual description or numerical description, to generate, based on evaluation target information including the news article text, the assertion sentences, the document information, and expert opinion information, a prompt sentence that describes, in a structured format, relationships among the assertion sentences, the primary source candidates, and the expert opinion information and that instructs a generative artificial intelligence model to evaluate a degree of match and a degree of consistency and to output, for each assertion sentence, support-degree information and basis explanation information as well as a reliability score for the news article on a numerical scale within a predetermined range, to input the prompt sentence to the generative artificial intelligence model and obtain evaluation result information including support-degree information, partial-support information, non-support information, and composite reliability information, to calculate, based on the evaluation result information and the document information, a reliability score of the news article as a numerical index, to generate a reliability category and warning information according to the reliability score, and to generate display data including display control information that causes a terminal device to perform emphasized display of an alert message and the reliability score when the reliability score does not satisfy a predetermined threshold condition and to transmit the display data to the terminal device. This enables the server, through a concrete sequence of machine operations, to convert unstructured textual content into structured evaluation inputs, to drive a generative model with formally constructed prompt sentences, to derive calibrated reliability scores and associated alert information, and to control presentation behavior at the terminal device level, thereby improving the technical functioning, efficiency, and consistency of computer-based news reliability evaluation on communication networks.

The term “news article text” refers to text data representing a written report or narrative intended to convey information about events, topics, or issues, and obtained from an information source on a communication network.

The term “text normalization” refers to a process performed by a computing device to convert raw text into a standardized representation, including at least one of character encoding conversion, removal or replacement of control characters, unification of punctuation, case normalization, and whitespace normalization.

The term “sentence segmentation” refers to a process performed by a computing device to divide a continuous text string into discrete sentence units based on linguistic rules, punctuation patterns, or learned models.

The term “natural language processing” refers to a set of computational techniques by which a computing device analyzes, interprets, and transforms human language text, including at least one of tokenization, part-of-speech tagging, syntactic parsing, and semantic analysis.

The term “entity information” refers to data representing identified real-world or conceptual entities occurring in text, such as persons, organizations, locations, dates, or technical terms, together with associated type labels and positional information.

The term “important phrase information” refers to data representing phrases or word sequences in text that are determined, by computational analysis, to be significant for understanding main topics, claims, or concepts within the text.

The term “search term” refers to a word, phrase, or combination thereof generated by a computing device for use as a query element when searching an information storage apparatus.

The term “search query” refers to a structured collection of search terms and optionally search conditions, used by a computing device to request relevant information from an information storage apparatus.

The term “document information storage apparatus” refers to a hardware and software system configured to store, index, and provide access to document information via an information network.

The term “information network” refers to a communication infrastructure and associated protocols that allow computing devices and storage apparatuses to exchange digital information, including wide-area networks and local-area networks.

The term “document information” refers to data representing textual or bibliographic content of a stored document, including at least one of a title, an abstract, an author field, a publication date, a source identifier, or a body text.

The term “primary source candidate” refers to document information retrieved from an information storage apparatus that potentially represents an original or foundational record relevant to a factual assertion contained in a news article text.

The term “candidate sentence” refers to a sentence extracted from a news article text and selected, by computational rules or models, as a potential carrier of a factual or numerical assertion.

The term “assertion sentence” refers to a sentence identified from among candidate sentences as including at least one explicit factual description or numerical description that can be evaluated against external information sources.

The term “factual description” refers to textual content that states a concrete fact, such as an event, a property, or a relationship, which is capable of being verified as true or false against external information sources.

The term “numerical description” refers to textual content that includes a numerical value, quantity, rate, percentage, or similar quantitative expression that is capable of being verified against external information sources.

The term “evaluation target information” refers to a structured aggregation of data used by a computing device to evaluate reliability of a news article, including at least the news article text, assertion sentences, document information of primary source candidates, and expert opinion information.

The term “expert opinion information” refers to data representing commentary, analysis, or judgments provided by a subject-matter expert or an expert group regarding a topic or claim related to a news article.

The term “prompt sentence” refers to a machine-generated or machine-formatted text string supplied as input to a generative artificial intelligence model, the text string specifying contextual information and instructions that guide the model's processing behavior.

The term “generative artificial intelligence model” refers to a trained machine learning model that, in response to an input including at least a prompt sentence, automatically generates output data such as natural language text or structured information.

The term “degree of match” refers to a measure computed by a computing device or a model that indicates how closely content of an assertion sentence corresponds to content of one or more primary source candidates.

The term “degree of consistency” refers to a measure computed by a computing device or a model that indicates how well content of an assertion sentence aligns with expert opinion information.

The term “support-degree information” refers to data indicating that a particular assertion sentence is judged to be supported by one or more primary source candidates and optionally expert opinion information.

The term “partial support information” refers to data indicating that a particular assertion sentence is judged to be supported in part, but not fully, by one or more primary source candidates and optionally expert opinion information.

The term “non-support information” refers to data indicating that a particular assertion sentence is judged not to be supported by one or more primary source candidates and optionally expert opinion information.

The term “composite reliability information” refers to data representing an overall assessment of reliability of a news article derived from evaluations of multiple assertion sentences and their relationships to external information sources.

The term “evaluation result information” refers to structured data output by a computing device or a generative artificial intelligence model that includes at least support-degree information, partial support information, non-support information, and composite reliability information.

The term “reliability score” refers to a numerical index, within a predetermined range, that quantitatively represents an assessed reliability level of a news article based on evaluation result information and document information.

The term “reliability category” refers to a classification label assigned to a news article, derived from a reliability score, and indicating a qualitative reliability level such as high, medium, or low.

The term “warning information” refers to data indicating that a news article has been assessed as having a reliability score below a predetermined threshold and that an alert should be presented to a user.

The term “display data” refers to data generated by a server and transmitted to a terminal device, the data including information used by the terminal device to render visual, audio, or other user-perceptible output.

The term “display control information” refers to data contained in display data that instructs a terminal device how to present certain information, including at least conditions and styles for emphasized display of alerts and scores.

The term “terminal device” refers to a user-operated computing apparatus capable of receiving data from a server over a communication network and presenting the data to a user, such as a mobile device, a tablet device, or a personal computer.

In at least one embodiment, a server cooperates with a terminal and a user to implement a reliability evaluation system for news article text distributed over an information network. The server is realized as a computing apparatus including at least one processor, a main memory, a non-volatile storage device, and a network interface. The server executes an operating system such as a general-purpose server operating system and middleware such as a web server and an application framework. The server stores executable programs and machine-learned model parameters in the non-volatile storage device and loads them into the main memory for execution by the processor.

In one embodiment, the server executes an application implemented using a programming language such as a high-level general-purpose language, together with a web framework such as a general-purpose web application framework, and a machine learning framework such as a tensor-based numerical computation framework. The server hosts one or more generative AI models as inference services, for example via a model serving framework that exposes HTTP or gRPC endpoints to the application. The server additionally uses a natural language processing library that provides tokenization, part-of-speech tagging, named-entity recognition, and sentence segmentation, and a vector-embedding library such as a sentence embedding toolkit to map text segments to continuous vector representations.

The terminal is realized as a user-operable computing device such as a smartphone, a tablet device, or a personal computer, including a processor, a display unit, an input device such as a touch panel, a memory, and a wireless or wired communication interface. The terminal executes a news reading application or a web browser. The terminal acquires news article text when the user accesses a news page and transmits the news article text, together with metadata such as a title and a source identifier, to the server via a communication network using a secure transport protocol.

The user operates the terminal to browse news content in a usual manner. The user does not need to manually collect external literature or expert commentary. The server automatically retrieves and processes such information and returns a reliability score and warning information, which are displayed to the user by the terminal.

In an embodiment, the server uses a modular architecture including a request reception module, a text preprocessing module, an analysis module, a retrieval module, a prompt construction module, a generative AI inference module, a scoring module, and a display data generation module. The server stores intermediate results in structured data records managed in a database management system or an in-memory key-value store.

The server performs text normalization by converting received news article text to a unified character encoding, eliminating control characters, standardizing punctuation, and normalizing whitespace. The server then performs sentence segmentation using a sentence boundary detection algorithm implemented in the natural language processing library. The server stores each sentence in a sentence table in memory, where each record includes a sentence identifier, character offset information, and a reference to the original article identifier. This explicit sentence structure allows the server to link subsequent analysis results to specific sentences.

The server performs natural language processing by executing tokenization, part-of-speech tagging, dependency parsing, and named-entity recognition on each sentence. The server uses a pre-trained transformer-based language model provided by a natural language processing library or a machine learning framework. The model converts each token into a high-dimensional embedding vector and outputs probability distributions over part-of-speech tags and entity types. The server stores, for each token, a token string, part-of-speech tag, dependency relation, and entity type in a token table. This structure enables later extraction of entity information and important phrase information with high recall and precision.

The server extracts entity information by selecting tokens or contiguous token spans labeled as entities such as “disease,” “medical intervention,” “numerical value,” “organization,” or “time period.” The server extracts important phrase information by combining multiple features, including term frequency-inverse document frequency values computed across a corpus of prior articles, attention weights obtained from the transformer layers of the language model, and syntactic roles such as subject, object, and complement derived from dependency parsing. The server assigns an importance score to each candidate phrase and stores the results in an importance table. By combining syntactic, statistical, and model-based features, the server improves robustness to noisy wording and reduces false positives compared with simple keyword counting.

The server generates search terms and search queries for document information storage apparatuses. The server constructs base search terms by selecting high-importance phrases that include domain-specific entities, such as an intervention name and an outcome measure. The server then adapts the base search terms into different query templates optimized for respective external databases. For example, the server may map key phrases into a structured query syntax that limits terms to title/abstract fields and constrains publication date ranges. For a more general search engine, the server may construct free-text queries with additional boolean operators. The server stores each outgoing query in a query log with a reference to the related article identifier and entity identifiers, which allows later auditing and performance tuning.

The server accesses document information storage apparatuses, which may be realized as external literature databases and internal document repositories. The server sends search queries via the network interface using an HTTP client library, receives response data in a structured format such as XML or JSON, and parses the data into an internal document structure including at least a title, an abstract, an author list, a publication date, and an identifier. The server then computes vector embeddings of each abstract using a sentence embedding model implemented in the machine learning framework. The server also computes a vector embedding of the news article text or of key sentences in the article. The server calculates cosine similarity between the article embeddings and the document embeddings and uses this similarity to rank the retrieved documents. The server selects a subset of top-ranked documents as primary source candidates and stores them in a source table.

The server acquires expert opinion information from an internal database that stores structured expert comments. Each record in the expert comment database includes a topic descriptor vector, a textual summary, a full comment text, an indication of expert domain, and a time stamp. The server computes a vector embedding of the article's central topic using the same sentence embedding model, and performs a nearest-neighbor search in the embedding space to retrieve comments whose topic descriptor vectors are closest to the article's topic vector. In one embodiment, the server uses a vector index structure such as an approximate nearest neighbor index to accelerate retrieval. The server thus acquires expert opinion information that is semantically aligned with the article's content instead of relying only on simple keyword matching.

The server identifies assertion sentences by applying both rule-based and model-based logic. The server first filters candidate sentences using heuristic rules such as the presence of numerical tokens, comparative adjectives, or causal connectors. The server then uses a classifier neural network, implemented for example as a transformer encoder followed by a fully connected layer, to assign a probability that a sentence contains at least one factual or numerical claim suitable for external verification. The server selects sentences with probabilities above a threshold as assertion sentences. For each assertion sentence, the server may further segment the sentence into claim clauses using dependency relations and coordinate structures.

The server constructs evaluation target information by associating each assertion sentence with a set of related primary source candidates and expert opinions. The server calculates similarity metrics between each assertion sentence and the abstract of each primary source candidate, and also between the assertion sentence and each expert comment. The server selects, for each assertion sentence, a subset of primary source candidates and expert comments that exceed a similarity threshold. The server organizes these associations in a structured record that includes: the assertion sentence text, identifiers of linked primary source candidates, short summaries of those sources, identifiers of linked expert comments, and short summaries of those comments.

The server generates a prompt sentence for a generative AI model based on the evaluation target information. In one embodiment, the server uses a template-based prompt generator. The server fills in template sections with the article text, a numbered list of assertion sentences, a structured list of primary source candidates (with titles and short abstracts), and summarized expert opinions. The server additionally inserts explicit instructions that define the expected output schema and scoring rules. An example prompt sentence is:

“You are a fact-checking assistant.

### Input

### 1. News Article Text

[ARTICLE TEXT]

### 2. Extracted Claims

(1) [ASSERTION SENTENCE 1]
(2) [ASSERTION SENTENCE 2]
. . .

### 3. Primary Sources

For each claim, the following items list titles and abstracts of related documents from scientific literature databases.
Claim (1) related documents:
[DOCUMENT TITLE 1]-[DOCUMENT ABSTRACT 1]
[DOCUMENT TITLE 2]-[DOCUMENT ABSTRACT 2]
. . .
Claim (2) Related Documents:
. . .

### 4. Expert Opinions

The following items summarize opinions of subject-matter experts related to the claims.
For claim (1): [EXPERT SUMMARY 1]
For claim (2): [EXPERT SUMMARY 2]
. . .

### Task

For each claim, determine whether the claim is supported, partially supported, or not supported by the primary sources and expert opinions. Provide a short explanation citing which sources or opinions are relevant. Then compute an overall reliability score between 0 and 100 for the news article, where 0 means completely unreliable and 100 means fully reliable. Output your result in the following structure:
Supported claims: list of claim numbers with explanations.
Partially supported claims: list of claim numbers with explanations.
Unsupported claims: list of claim numbers with explanations.
Overall reliability score: [SCORE BETWEEN 0 AND 100].
Brief explanation of the score.”

In another example, the server generates a prompt sentence focusing more on numerical verification:

“Analyze the following news article.

Identify all numerical claims, such as percentages, risk reductions, or sample sizes.

Compare each numerical claim against the attached abstracts of related scientific publications.

Determine whether each numerical claim is consistent, approximately consistent, or inconsistent with the values reported in the publications.

Then calculate a reliability score between 0 and 100 that reflects both factual and numerical consistency.

Return a concise explanation of the most important reasons for the score.”

The server inputs the prompt sentence to the generative AI model. In one embodiment, the generative AI model is realized as a transformer-based neural network with multiple attention layers, feed-forward layers, and layer normalization. The model is trained on large-scale corpora of factual text and fine-tuned on datasets containing labeled claim-support relationships and reliability scores. The model parameters include weight matrices and bias vectors for each transformer layer, positional encoding parameters, and output projection matrices. During fine-tuning, the server or an off-line training system employs an optimization algorithm such as stochastic gradient descent with adaptive moment estimation, uses a loss function that combines cross-entropy loss for support-category classification and mean squared error for reliability score regression, and performs weight updates based on backpropagation. Training data may include augmented examples in which claims are paraphrased, numerical values are slightly perturbed, or irrelevant sources are inserted, allowing the model to learn robustness to linguistic variation and noise.

At inference time, the server converts the prompt sentence into token IDs using a tokenizer consistent with the model architecture, passes the token sequence through the transformer layers, and obtains output token logits. The server constrains the model output to a desired structure by appending format examples to the prompt or by using a constrained decoding algorithm. The server then parses the generated text output to extract structured evaluation result information, including which claims are supported, partially supported, or not supported, and the overall reliability score.

The server calculates a reliability score as a numerical index by combining the model output with external signal features. For example, the server may compute a weighted sum of: (i) the model-provided score, (ii) an average support probability across all assertion sentences, (iii) a penalty term proportional to the fraction of unsupported claims, and (iv) a weight related to the quality of primary sources (for example, whether sources are peer-reviewed). The server may implement this combination as a secondary regression model trained on historical evaluation data. The server then maps the numerical reliability score to a reliability category such as “high,” “medium,” or “low,” and generates warning information if the score falls below a threshold.

The server generates display data for the terminal that includes the reliability score, reliability category, warning information, and display control information. The display control information specifies, for example, that for low reliability categories, the terminal should render a persistent banner in a contrasting color and display a concise warning text overlaid near the article title. The terminal receives the display data, decodes the control information, and configures rendering components of its user interface framework accordingly. This configuration may include font size changes, color palette selection, and the ordering of information panels. In this way, the system is not limited to simple data transfer; instead, the server actively determines a display policy based on computed reliability characteristics and instructs the terminal to modify its behavior.

This architecture yields technical improvements beyond mere automation of human evaluation. Because the server organizes text into explicit assertion sentences, links them algorithmically to primary source candidates and expert opinions, and constructs structured prompt sentences, the generative AI model operates on a more informative and constrained input space. This reduces unnecessary token processing, shortens prompt length, and thereby decreases computation time and network bandwidth used for model invocation. The explicit association of claims, sources, and expert opinions also reduces ambiguity in model inference, leading to more stable and reproducible reliability scores. The use of vector embeddings and approximate nearest neighbor search structures allows the server to access relevant references in sub-linear time with respect to the size of the document corpus, improving scalability and latency.

Furthermore, the server's use of calibrated scoring functions and threshold-based display control information enables a predictable and machine-verifiable mapping from low-level text features to high-level user interface behavior. This is distinct from a human operator manually inspecting sources, because the machine-enforced thresholds, structured data models, and explicit instructions to the generative AI model are integral to the operation of the computing system. The combination of these elements yields a technical effect of reducing inconsistent outputs, lowering error rates in claim classification, and decreasing end-to-end response time for reliability evaluation, especially under high-load conditions when many terminals request evaluation simultaneously.

In alternative embodiments, the server may use different model architectures, such as encoder-decoder transformers instead of decoder-only transformers, or may incorporate additional feature extraction modules that compute symbolic logic features, such as contradiction indicators derived from textual entailment models. The server may also perform on-device portions of the computation on the terminal, for example performing preliminary sentence segmentation and tokenization locally to reduce the amount of data transmitted to the server. Such variants still follow the core concept of transforming unstructured news text into structured evaluation target information, generating constrained prompt sentences, and using generative model outputs in a deterministic scoring and display pipeline.

The user interacts with the system by viewing news articles and observing the displayed reliability score and warnings. The user may optionally request additional detail, in which case the terminal may request from the server a breakdown of supported and unsupported claims and primary source summaries. The server responds with structured information that the terminal renders as an expandable panel or separate view. This additional interaction does not change the core processing but illustrates how the system provides transparent reasoning traces derived from the structured associations and generative model explanations.

Accordingly, the embodiments described above provide concrete guidance on implementing the invention with specific hardware, software components, data structures, and neural network configurations. The server, terminal, and user cooperate through these technical components to realize a news reliability evaluation mechanism that improves processing efficiency, evaluation accuracy, and user-facing presentation in a way that goes beyond simple automation of human judgment.

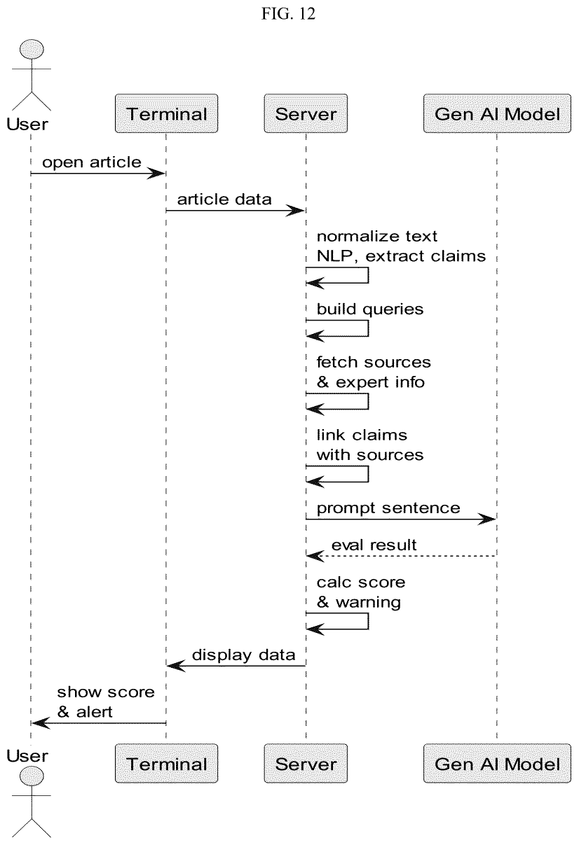

The following describes the processing flow using FIG. 12.

### Step 1

Terminal acquires news article text and sends it to the server.

Terminal receives, as input, a news article page rendered by a news application or web browser that the user has opened. Terminal parses the page to extract a title string, a body text string, and optional metadata such as a publication date and a source identifier. Terminal removes unnecessary markup such as script tags and style tags and normalizes line breaks. Terminal then constructs a structured message including at least the title, the body text, and a terminal identifier, and transmits this message to the server over a secure communication channel. The output of this step is a network request containing structured news article data addressed to the server.

### Step 2

Server receives the news article data and performs basic validation.

Server accepts, as input, the structured message from the terminal via a network interface. Server decodes the message, verifies that required fields such as title and body text are present, and checks that the body text length falls within a configured range. Server assigns a unique article identifier, stores the raw text and metadata in a storage apparatus, and records a log entry including the article identifier, terminal identifier, and a timestamp. The output of this step is a validated article record stored with an associated article identifier.

### Step 3

Server performs text normalization and sentence segmentation.

Server receives, as input, the validated article record including the raw news article text. Server converts the text into a uniform character encoding, removes control characters, standardizes punctuation, and collapses redundant whitespace. Server then applies a sentence boundary detection algorithm provided by a natural language processing library to segment the normalized text into discrete sentences. Server assigns a sentence identifier to each sentence and records the sentence text and its character offsets into a sentence list linked to the article identifier. The output of this step is a normalized article text and a structured sentence list.

### Step 4

Server performs token-level and sentence-level linguistic analysis.

Server receives, as input, the normalized article text and the sentence list. Server invokes a natural language processing model to perform tokenization, part-of-speech tagging, syntactic dependency parsing, and named-entity recognition on the text. Server converts each sentence into a sequence of tokens and assigns, to each token, a part-of-speech tag, a dependency label, and an entity type probability. Server stores tokens, tags, and dependency relations in a token table indexed by sentence identifiers. The output of this step is a set of annotated tokens and dependency structures associated with the article.

### Step 5

Server extracts entity information and important phrase information.

Server receives, as input, the annotated tokens and dependency structures. Server identifies entity spans by grouping consecutive tokens labeled with entity types such as medical condition, intervention, organization, or date. Server also computes importance scores for candidate phrases using features such as term frequency-inverse document frequency values across a background corpus, attention weights from transformer layers, and syntactic roles such as subject and object. Server selects phrases whose importance scores exceed a threshold and stores entity information and important phrase information in an entity-and-phrase list. The output of this step is a structured list of entities and important phrases linked to the article.

### Step 6

Server generates search terms and search queries for external document sources.

Server receives, as input, the entity-and-phrase list. Server selects domain-relevant entities and phrases, such as a disease name, an intervention name, and an outcome measure, and combines them into base search term sets. Server then maps these base search terms into search queries specific to various document information storage apparatuses, for example by adding field constraints for titles and abstracts or by restricting publication dates. Server records, for each target storage apparatus, a search query string and associated parameters such as a maximum number of results and a language filter. The output of this step is a set of search queries configured for external and internal document databases.

### Step 7

Server retrieves primary source candidate documents from document information storage apparatuses.

Server receives, as input, the set of configured search queries. Server sends each query to the corresponding document information storage apparatus via an application programming interface over a network connection. Server receives response data including document records containing titles, abstracts, author lists, publication dates, and identifiers. Server parses the responses and constructs a normalized document record for each returned item. Server then applies a relevance filter, for example by calculating lexical overlap scores between article phrases and document titles or by computing cosine similarity between vector embeddings of the article text and document abstracts. Server selects a subset of top-ranked documents as primary source candidates and stores them in a source table linked to the article identifier. The output of this step is a set of primary source candidate document records associated with the article.

### Step 8

Server retrieves expert opinion information related to the article topic.

Server receives, as input, the entity-and-phrase list and, optionally, a topic embedding of the article computed by a sentence embedding model. Server queries an internal expert comment database using a combination of keyword search and similarity search in an embedding space. Server selects expert comments whose topic descriptors or embeddings are close to the article topic and whose timestamps satisfy freshness conditions. Server stores expert opinion information including summary text, full comment text, expert domain, and identifiers in an expert-comment list associated with the article identifier. The output of this step is a set of expert opinion records relevant to the article.

### Step 9

Server identifies candidate sentences and assertion sentences in the article.

Server receives, as input, the sentence list and the annotated tokens. Server first selects candidate sentences that contain indicative patterns, such as numerical tokens, comparative expressions, or strong modal verbs. Server then applies a classifier model that outputs a probability that each candidate sentence contains a factual or numerical assertion suitable for verification. Server compares the probabilities with a threshold, and labels sentences exceeding the threshold as assertion sentences. Server stores assertion sentences with their sentence identifiers and probabilities in an assertion list. The output of this step is a structured list of assertion sentences derived from the article.

### Step 10

Server associates assertion sentences with primary source candidates and expert opinions.

Server receives, as input, the assertion list, the set of primary source candidate documents, and the expert-comment list. Server computes, for each assertion sentence, similarity scores to document abstracts and expert comment texts using vector embeddings and cosine similarity. Server selects, for each assertion sentence, one or more primary source candidates and expert comments whose similarity scores exceed respective thresholds. Server records associations in an evaluation-target structure that maps each assertion sentence to its related documents and expert opinions. The output of this step is evaluation target information that explicitly links assertion sentences, primary source candidates, and expert opinions.

### Step 11

Server constructs a prompt sentence for a generative AI model.

Server receives, as input, the evaluation target information and the original or summarized news article text. Server formats a prompt sentence that describes, in text form, the news article, a numbered list of assertion sentences, a list of associated primary source titles and abstracts for each assertion, and summarized expert opinions. Server also inserts explicit instructions on how the generative AI model should evaluate support, partial support, and non-support, and how it should compute and output an overall reliability score. Server ensures that the prompt sentence does not exceed a predefined token length by truncating or summarizing less critical items. The output of this step is a fully constructed prompt sentence ready to be input to the generative AI model.

### Step 12

Server inputs the prompt sentence to the generative AI model and obtains evaluation result information.

Server receives, as input, the constructed prompt sentence. Server tokenizes the prompt according to the tokenization scheme of the generative AI model and forwards the token sequence to the model's inference API. The model processes the prompt and generates output text that follows the requested structure, containing at least a list of supported claims, a list of partially supported claims, a list of unsupported claims, explanations referencing documents and expert comments, and an overall reliability score. Server captures the generated output text and parses it into structured evaluation result information with fields for support-degree information, partial support information, non-support information, and composite reliability information. The output of this step is structured evaluation result information derived from the generative AI model's response.

### Step 13

Server calculates a reliability score and generates reliability category and warning information.

Server receives, as input, the structured evaluation result information and the primary source candidate records. Server reads the overall reliability score proposed by the model and may adjust it using additional features, such as the proportion of unsupported assertion sentences and indicators of document quality. Server normalizes the adjusted score into a predefined numerical range and classifies the score into a reliability category such as high, medium, or low according to threshold values. Server determines whether warning information should be generated based on the category or whether the score falls below a warning threshold. Server constructs reliability category data and warning information that describe, for example, that the article has low reliability and that caution is recommended. The output of this step is a final numerical reliability score, a reliability category, and associated warning information.

### Step 14

Server generates display data and transmits it to the terminal.

Server receives, as input, the reliability score, the reliability category, the warning information, and optionally selected explanations from the evaluation result information. Server embeds these elements into display data that includes display control information specifying how the reliability score and warning should be emphasized, such as color codes, recommended layout positions, or emphasis flags. Server sends the display data to the terminal via a network response. The output of this step is a network response containing display data configured for rendering on the terminal.

### Step 15

Terminal presents the reliability score and warning to the user.

Terminal receives, as input, the display data from the server. Terminal interprets the display control information and updates its user interface to render the reliability score and reliability category near the news article title, and, if warning information is present, to show an emphasized alert message using a distinct color or banner. Terminal may also provide a control element that the user can activate to view detailed supported and unsupported claims. The output of this step is a visual presentation of the reliability evaluation to the user on the terminal display.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In networked computing environments, users increasingly rely on digital information whose origin and accuracy are difficult to verify at scale. Conventional fact-checking workflows often require human experts to manually search multiple information sources, interpret heterogeneous documents, and synthesize a reliability judgment. This results in high latency, low throughput, and inconsistent quality, and does not leverage modern natural language processing capabilities in a systematic, machine-executable manner.

Existing automated approaches typically apply fixed keyword extraction and straightforward search queries against information networks. Such approaches struggle to capture the semantic nuances of user-provided information, and therefore retrieve incomplete or noisy external information. As a result, the computed reliability indicators are unstable and can be biased toward superficial text matches rather than deeper semantic alignment with primary information sources.

Moreover, conventional systems do not effectively integrate a generative AI model into the core information-processing pipeline in a way that structurally improves the computational process itself. In many cases, generative models are used only to rewrite user text or produce summaries, without being integrated into the construction of optimized search terms, the structured comparison between input information and external information, and the generation of machine-usable reliability assessments. This leads to a separation between semantic understanding and search logic, limiting the precision and robustness of automated reliability evaluation.

Additionally, typical systems provide only raw scores or simplistic indicators without generating a machine-structured, explanation-oriented representation of why a given reliability result was obtained. As a consequence, downstream components and user interfaces cannot easily present transparent, reproducible explanations, and cannot systematically reuse intermediate computational artifacts such as weighted similarity measures or model-based relationship determinations.

Therefore, there is a need for an improved computer-implemented technique that (i) automatically extracts important linguistic elements from input information, (ii) uses a generative AI model via carefully constructed prompt sentences to generate semantically enriched search terms, (iii) performs structured retrieval and similarity analysis over external information sources with reliability weighting, and (iv) automatically produces explanation-oriented outputs. Such a technique should improve the efficiency, accuracy, and consistency of reliability evaluation in a way that constitutes a concrete improvement to computer-based information processing rather than a mere automation of human mental judgment.

The specific processing by the specific processing unit 290 of the data processing device 12 in Example 2 is realized by the following means.

The present invention provides a server comprising a processor configured to acquire input information from a terminal, analyze the input information by using a natural language processing program to perform segmentation into linguistic units and assignment of parts of speech, extract important terms from the input information, generate a first prompt sentence based on the extracted important terms, input the first prompt sentence into a generative AI model and obtain related terms from the generative AI model, generate an expanded search term group including the important terms and the related terms, search information sources on an information communication network by using the expanded search term group and acquire, as search results, a plurality of pieces of external information, perform similarity calculation between the input information and the external information and assign reliability weights based on attributes of information providers of the external information to calculate a reliability evaluation value for the input information, generate a second prompt sentence for generating an explanation text regarding reliability of the input information based on the reliability evaluation value and the external information, input the second prompt sentence into the generative AI model and obtain a reliability explanation text from the generative AI model, and output the reliability evaluation value and the reliability explanation text to the terminal. This enables the server to realize a technically improved information-processing pipeline in which natural language processing and generative AI-based prompt sentences are used to produce optimized search terms, semantically grounded similarity and weighting computations, and structured explanation outputs, thereby enhancing the accuracy, efficiency, and transparency of computer-implemented reliability evaluation for networked information.

The term “input information” refers to text data or other linguistic content provided from a terminal or another computing device to the server for reliability evaluation processing.

The term “natural language processing program” refers to a software component executed by the processor that analyzes human language text, including at least tokenization, part-of-speech tagging, and extraction of linguistic features such as terms and name expressions.

The term “segmentation into linguistic units” refers to processing that divides input information into discrete elements such as words, morphemes, or tokens suitable for further linguistic analysis by the processor.

The term “assignment of parts of speech” refers to processing that labels each linguistic unit in the input information with a grammatical category such as noun, verb, adjective, or adverb.

The term “important terms” refers to linguistic units or phrases selected from the input information based on predetermined criteria, such as frequency, grammatical role, or semantic relevance, which represent key concepts or entities contained in the input information.

The term “first prompt sentence” refers to a text instruction generated by the processor and supplied to a generative AI model, the text instruction including at least the important terms and defining a task for generating related terms or other output.

The term “generative AI model” refers to a machine learning model configured to generate text or other content in response to input data, including at least a large-scale language model that produces output based on the first prompt sentence or the second prompt sentence.

The term “related terms” refers to linguistic expressions generated by the generative AI model in response to the first prompt sentence, the expressions having a semantic relationship to the important terms and being usable for search or analysis.

The term “expanded search term group” refers to a set of search expressions generated by the processor that includes the important terms and the related terms, and that is used as input to search processing on an information communication network.

The term “information communication network” refers to a communication infrastructure such as the Internet or another digital network that connects the server to external information sources.

The term “information sources” refers to data repositories or services accessible via the information communication network, including at least document collections, databases, or search services that provide external information in response to search queries.

The term “external information” refers to information items, such as documents, records, or snippets of text, obtained from information sources on the information communication network as search results based on the expanded search term group.

The term “similarity calculation” refers to computational processing that quantifies a degree of similarity between the input information and each piece of external information, using at least one metric such as vector similarity, lexical overlap, or semantic similarity.

The term “attributes of information providers” refers to characteristics of entities that provide the external information, including at least domain type, source category, or known reliability class associated with the external information.

The term “reliability weights” refers to numerical values assigned by the processor to pieces of external information based on the attributes of information providers, the values being used to adjust the influence of the external information in calculating the reliability evaluation value.

The term “reliability evaluation value” refers to a quantitative or categorical indicator generated by the processor that represents an evaluation of reliability of the input information, calculated based on the similarity calculation and the reliability weights.

The term “second prompt sentence” refers to a text instruction generated by the processor and supplied to the generative AI model, the text instruction including at least the reliability evaluation value and information derived from the external information, and defining a task for generating an explanation text.

The term “reliability explanation text” refers to natural language text generated by the generative AI model in response to the second prompt sentence, the text describing reasons or grounds for the reliability evaluation value of the input information.

The term “terminal” refers to an information processing device, such as a client computer, mobile device, or other user interface device, configured to transmit the input information to the server and receive the reliability evaluation value and the reliability explanation text. The term “processor” refers to one or more hardware processing units, such as a central processing unit, graphics processing unit, or dedicated accelerator, configured to execute instructions that implement the functions of the server described in the claims.

In one embodiment, a server implements the claimed system by executing a set of software modules on one or more hardware processors. The server includes at least one central processing unit (CPU), and may further include one or more graphics processing units (GPUs) configured for acceleration of neural network inference. The server executes an operating system such as a general-purpose server operating system, and runs application software including a web application framework, a natural language processing program, a generative AI model inference program, and search interface modules for accessing information communication networks.

The server uses a natural language processing program implemented, for example, by a library such as a statistical or neural network-based text processing framework. This program performs tokenization, part-of-speech tagging, and named entity recognition on input information. The server loads a language model, such as a neural sequence tagging model composed of an embedding layer, a recurrent or transformer-based encoder, and a classification layer, into main memory. The server causes the CPU and, when available, the GPU to cooperate in executing matrix operations required for the language model, thereby obtaining part-of-speech labels and entity labels for each token of the input information. By representing the input information as a structured sequence of tokens with associated tags, the server generates a data structure that is more suitable for downstream computation than the original unstructured text.

The server extracts important terms from the structured representation by applying algorithmic rules and statistical criteria. For example, the server identifies tokens with noun or verb tags, high term frequency within the input information, or presence in specific named entity categories such as organizations, locations, or technical objects. The server stores these important terms in a vector data structure or a key-value map, and assigns each term a relevance score based on term frequency-inverse document frequency, position in the input information, and syntactic role. This combination of linguistic and statistical features allows the server to automatically select terms that capture the semantic core of the input information with improved precision compared to simple keyword matching.

The server then generates a first prompt sentence for a generative AI model. The server constructs this prompt sentence as a text instruction that includes at least the important terms and a description of a required task. The server may, for example, generate a prompt sentence such as:

“You are a system that generates search keywords for fact-checking.

Original text: ‘[short summary of the input information]’

Extracted important terms: [term1, term2, term3].

Generate 10 additional related keywords or short phrases that would help verify this information using reliable information sources on an information communication network. Return only the list of keywords as plain text.”

The server supplies the first prompt sentence to a generative AI model. In one embodiment, the generative AI model is implemented by a large-scale neural language model using a transformer architecture. The model includes multiple layers of self-attention, feed-forward blocks, and layer normalization, with learned parameters representing word embeddings, positional encodings, and attention weights. The model parameters are stored in the server's non-volatile storage and loaded into GPU memory or main memory for inference. The server performs inference by executing sequences of matrix multiplications and non-linear activation functions, thereby generating text tokens autoregressively in response to the first prompt sentence.

The server obtains, as related terms, the output tokens generated by the generative AI model. The server parses the output text into individual terms or phrases and may filter them according to predefined rules, such as removal of overly generic terms or terms that do not meet a minimum character length. The server merges the related terms with the previously extracted important terms to create an expanded search term group. The server can store this expanded search term group as an array of strings or as a feature vector representation generated by applying an embedding model, such as a sentence embedding network, to each term.

The server uses the expanded search term group to query information sources on an information communication network. The server connects to external search services, such as general web search interfaces or news search interfaces, through HTTP or HTTPS communication protocols. The server constructs search queries by combining terms from the expanded search term group using logical operators and query syntax appropriate for each external search service. The server sends these search queries as network requests and receives search results encoded, for example, in structured formats such as text-based markup or structured data formats.

The server extracts from the received search results a plurality of pieces of external information, including at least document titles, snippets, addresses, and provider identifiers. The server stores the external information in a data structure such as a list of records, where each record includes text fields and metadata fields. The server normalizes the external information by converting character encodings, removing markup symbols, and standardizing date and source representations.

The server computes similarity between the input information and each piece of external information. For this purpose, the server may generate vector representations of the input information and external information by using an embedding model that maps texts to points in a high-dimensional space. The embedding model can be implemented as a separate neural network, such as a transformer-based sentence encoder trained to minimize a distance measure between semantically similar texts. The server calculates cosine similarity or another distance-based metric between the embedding of the input information and the embedding of each piece of external information. In addition, the server may compute lexical overlap measures, n-gram similarity, and named entity overlap to form a multi-dimensional similarity feature vector for each pair of input and external information.

The server assigns reliability weights to each piece of external information based on attributes of information providers. The server maintains, for example, a mapping from domain categories or provider identifiers to numerical weights. The server may assign a higher weight to providers categorized as official institutions or primary information sources, and a lower weight to providers categorized as unknown or non-authoritative. The server multiplies similarity metrics by these reliability weights to obtain weighted similarity scores. By performing this weighting within the processor, the server implements a non-conventional combination of semantic similarity and source reliability, which improves the stability and robustness of the reliability evaluation value compared to systems relying solely on unweighted similarity.

The server calculates a reliability evaluation value for the input information by aggregating the weighted similarity scores across the plurality of external information items. The server may compute a weighted average, a maximum value, or a more complex function that considers distributions of supporting and contradicting evidence. In one embodiment, the server categorizes external information into support, contradict, or unrelated categories by further using relationship determinations obtained from the generative AI model. The server thus can assign higher contributions to external information that strongly supports the input information while reducing the influence of inconsistent or low-reliability sources.

The server generates a second prompt sentence for obtaining an explanation text regarding reliability. The second prompt sentence includes at least the reliability evaluation value, summary descriptions of the most influential external information, and an instruction for producing a concise explanation. An example of such a prompt sentence is:

“You are a fact-checking assistant for end users.

Claim: ‘[main claim extracted from the input information]’

Reliability score: [numerical value]

Supporting sources: [list of source titles and types].

Contradicting sources: [list if any].

Explain, in about 150 words, why the reliability score was assigned, referring to the types of sources and the degree of agreement or disagreement.”

The server inputs the second prompt sentence into the same or another generative AI model. The model executes transformer-based inference as described above and generates a reliability explanation text that is structured and understandable by a general user. The server may perform post-processing on the explanation text, such as removal of extraneous phrases or normalization of terminology, and then outputs the reliability evaluation value and the reliability explanation text to a terminal used by the user.

The terminal operates as a client device, such as a general-purpose computing device or a portable communication device. The terminal executes a user interface application that sends the input information to the server and receives the reliability evaluation value and reliability explanation text from the server. The terminal displays these results on a display unit, for example, by presenting a graphical indicator of the reliability evaluation value and a textual explanation. The terminal may further allow the user to select links to external information, thereby enabling the user to inspect the underlying sources.

The user provides input information to the terminal by typing or pasting text into an input form. The user may trigger reliability evaluation by operating a user interface element. The user then reviews the reliability evaluation value and explanation presented by the terminal to decide whether to rely on the input information.

In one embodiment, the server uses a generative AI model that has been trained using supervised learning and unsupervised pre-training. During pre-training, the model learns statistical dependencies in large-scale text corpora by minimizing a prediction error function, such as cross-entropy loss between predicted tokens and actual tokens. The server or a separate training system updates model parameters through gradient-based optimization, such as stochastic gradient descent with adaptive learning rate methods. During fine-tuning for fact-checking support, the system may further train the model on pairs of prompt sentences and desired outputs to improve the model's ability to generate useful related terms and explanation texts.

The server's processing is not a mere automation of human judgment; instead, it introduces specific data structures and algorithmic steps that improve computer-based information processing. By converting raw input information into structured linguistic representations, generating optimized search term groups using model-based semantic expansion, and combining similarity calculation with reliability weighting, the server reduces unnecessary network traffic and avoids retrieval of irrelevant external information. This leads to fewer network requests and faster response times compared to naive repeated keyword searches. The use of weighted similarity measures and model-assisted relationship determinations reduces computational waste by focusing further analysis on a limited set of highly relevant external information items.

The server further improves accuracy and reduces error by integrating feedback from the generative AI model into the reliability evaluation pipeline in a structured manner. For example, when the server queries the generative AI model to classify relationships between the input information and external information (support, contradict, unrelated), the server receives machine-readable labels and reasons, rather than free-form narrative text alone. The server stores these labels in association with external information records and uses them in the calculation of the reliability evaluation value. This integration permits reproducible and auditable computations that can be tuned and extended without re-training the entire model. In another embodiment, the server may use alternative natural language processing programs or embedding models. For example, the server may replace the transformer-based encoder with a convolutional neural network-based encoder or a recurrent neural network-based encoder for generating vector representations. The server may also employ different similarity metrics, such as Euclidean distance or learned similarity functions, and may implement different aggregation strategies for computing the reliability evaluation value, such as logistic regression or gradient boosting models applied to features derived from similarity scores and provider attributes.

In still another embodiment, the server may adapt the prompt sentences dynamically based on context. The server may, for example, automatically adjust the number of related terms requested from the generative AI model, or include additional metadata such as domain categories or time periods in the prompt sentences. By doing so, the server can optimize the trade-off between search breadth and computational cost based on system load and user requirements.

The technical effects provided by the server include improved processing speed, improved reliability evaluation accuracy, reduced network load, and improved data management. The server reduces latency by generating semantically enriched search terms in a single model-assisted step, thereby reducing the number of trial-and-error search queries. The server improves accuracy and reduces errors by systematically weighting external information based on provider attributes and by using structured, model-assisted relationship determinations. The server improves data management by maintaining internal data structures that link input information, important terms, expanded search term groups, external information, and reliability evaluation values, thus enabling efficient retrieval, auditing, and reuse of intermediate processing results.

Because the server implements these functions using specific hardware resources and software modules arranged in a non-conventional manner, the invention provides a concrete improvement in computer technology related to information retrieval and reliability assessment, rather than merely automating an abstract mental process.

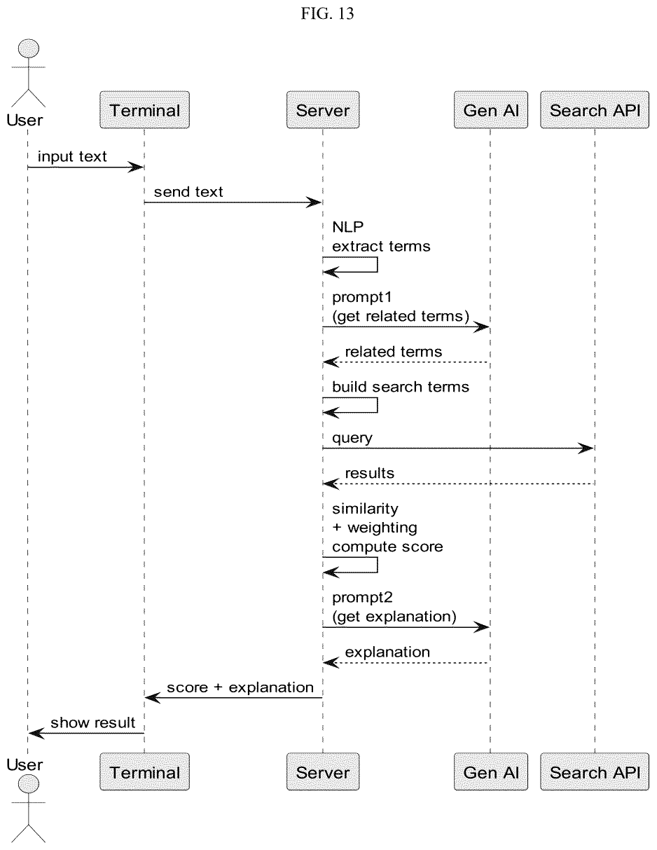

The following describes the processing flow using FIG. 13.

### Step 1

User provides input information via the terminal.

User operates the terminal to open an application screen, inputs or pastes a text to be evaluated into a text field, and triggers a send operation by pressing a button.

Terminal packages the input text and optional user instruction into a data structure and transmits it to the server over a communication network.

Input: user's raw text and optional instruction entered on the terminal.

Output: a network request containing the user's text and instruction, sent from the terminal to the server.

### Step 2

Server receives and stores the raw input information.

Server accepts the network request through a network interface, validates the request format, and parses the received data to extract the input text and the instruction.

Server assigns a unique identifier to the request and stores the raw text and metadata in a storage system for subsequent processing.

Input: network request containing the user's raw text and instruction.

Output: stored raw text and associated metadata identified by a unique request identifier.

### Step 3

Server performs linguistic preprocessing using a natural language processing program.

Server loads a language model and executes tokenization, part-of-speech tagging, and named entity recognition on the raw text by performing matrix operations and rule-based tagging on the processor.

Server converts the text into a sequence of tokens, each annotated with a part-of-speech tag and, when applicable, an entity type.

Input: stored raw text associated with a request identifier.

Output: a structured representation of the text including tokens, part-of-speech tags, and entity labels.

### Step 4

Server extracts important terms from the structured representation.

Server evaluates each token and phrase using criteria such as part-of-speech category, occurrence frequency, syntactic role, and entity type, and selects those that are likely to represent key concepts.

Server assigns a relevance score to each candidate term and filters out low-scoring candidates to form a set of important terms.

Input: structured representation containing tokens, tags, and entities.

Output: a list of important terms with associated relevance scores.

### Step 5

Server generates a first prompt sentence for a generative AI model.

Server constructs a textual instruction that embeds a concise summary of the input text and the extracted important terms, and describes a task for generating related terms.

Server concatenates fixed instruction phrases with the important terms into a single prompt sentence suitable for input to a language model.

Input: list of important terms and, optionally, a short summary of the input text.

Output: a first prompt sentence that instructs a generative AI model to produce related terms.

### Step 6

Server obtains related terms from the generative AI model.

Server sends the first prompt sentence to a generative AI model interface, which executes neural network inference to generate text output based on the prompt sentence.

Server receives the generated text, splits it into separate terms or phrases, and filters the results according to predefined rules, such as minimum length or removal of exact duplicates.

Input: first prompt sentence supplied to the generative AI model.

Output: a set of related terms generated in response to the first prompt sentence.

### Step 7

Server constructs an expanded search term group.

Server merges the important terms and the related terms into a unified collection, normalizes the terms by converting case and removing unnecessary punctuation, and removes overlapping or redundant entries.

Server stores the resulting terms in a list or array and, if required, converts each term to an embedding vector for later similarity processing.

Input: list of important terms and set of related terms.

Output: expanded search term group comprising normalized and deduplicated search terms.

### Step 8

Server performs external search using the expanded search term group.

Server forms one or more search queries by combining the terms with logical operators and formatting the queries according to the syntax required by external search services.

Server sends the queries as network requests to search interfaces on an information communication network and receives structured search results.

Input: expanded search term group.

Output: raw search results obtained from multiple external information sources.

### Step 9

Server extracts and normalizes external information from the search results.

Server parses each search result to obtain document titles, snippets, addresses, provider identifiers, and timestamps, and stores them as records in a structured data container.

Server performs normalization by decoding character sets, removing markup, and standardizing provider and date formats to create a consistent representation.

Input: raw search result data received from external search services.

Output: a collection of normalized external information records with text fields and metadata.

### Step 10

Server computes similarity between the input information and external information.

Server generates vector representations of the input text and each external information text using an embedding model, then calculates similarity metrics such as cosine similarity or lexical overlap for each pair.

Server stores similarity values in association with the corresponding external information records for later aggregation.

Input: raw input text and normalized external information records.

Output: similarity scores linking the input text to each piece of external information.

### Step 11

Server assigns reliability weights based on attributes of information providers.

Server evaluates attributes such as provider domain category, known reliability class, or source type, and maps these attributes to numerical weight values using a predefined table or rule set.

Server multiplies similarity scores by the corresponding reliability weights to generate weighted similarity scores, thereby emphasizing contributions from high-reliability sources.

Input: similarity scores and provider attributes for each external information record.

Output: weighted similarity scores reflecting both textual similarity and provider reliability.

### Step 12

Server calculates a reliability evaluation value for the input information.

Server aggregates the weighted similarity scores across the external information records using an aggregation function, such as a weighted average or a non-linear combination, to compute a single numerical indicator.

Server optionally categorizes the numerical indicator into a qualitative label, such as high, medium, or low reliability, based on predetermined thresholds.

Input: weighted similarity scores for the set of external information records.

Output: reliability evaluation value and, optionally, a corresponding reliability label for the input information.

### Step 13

Server prepares summary data for explanation generation.

Server selects a subset of external information records that most strongly influence the reliability evaluation value, such as those with highest weighted similarity scores.

Server constructs simplified descriptions of these selected records, including titles, source types, and brief text snippets, and stores them as explanation input data.

Input: reliability evaluation value and weighted similarity scores associated with external information.

Output: explanation input data containing representative external information summaries.

### Step 14

Server generates a second prompt sentence for explanation.

Server assembles a text instruction that includes the reliability evaluation value, the explanation input data, and a directive to create a concise explanation understandable by a user.

Server structures this content into a coherent second prompt sentence that specifies length, tone, and key elements to be referenced in the explanation text.

Input: reliability evaluation value and explanation input data.

Output: a second prompt sentence instructing a generative AI model to generate a reliability explanation text.

### Step 15

Server obtains a reliability explanation text from the generative AI model.

Server transmits the second prompt sentence to the generative AI model, which performs neural network inference to produce explanatory text that cites the reliability evaluation value and external information.

Server receives the generated explanation text, optionally removes extraneous content, and formats the text for presentation on the terminal.

Input: second prompt sentence supplied to the generative AI model.

Output: reliability explanation text describing reasons for the reliability evaluation value.

### Step 16

Server sends evaluation results to the terminal.

Server packages the reliability evaluation value, the optional reliability label, and the reliability explanation text into a response data structure and transmits this structure to the terminal over the communication network.

Server may also include identifiers or links to the most influential external information records for optional display on the terminal.

Input: reliability evaluation value, reliability label, reliability explanation text, and optional external information identifiers.

Output: response message containing evaluation results sent from the server to the terminal.

### Step 17

Terminal displays the reliability evaluation and explanation to the user.

Terminal receives the response message from the server, parses the contained data, and renders the reliability evaluation value and explanation text on a display screen.

Terminal may present a visual indicator for the reliability evaluation value and provide interactive elements allowing the user to access external information links.

Input: response message containing reliability evaluation value and reliability explanation text.

Output: displayed evaluation and explanation visible to the user on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In networked computing environments, conventional fact-checking and news-evaluation systems primarily rely on simple keyword search, rule-based comparison, or static scoring models. These systems typically (i) perform shallow text matching between a news article and external data sources, (ii) do not leverage generative AI models in a structured, controllable manner, (iii) do not combine heterogeneous signals such as primary-source consistency, expert-opinion alignment, and emotion-related information, and (iv) do not generate machine-interpretable intermediate representations that can be used to improve the operation of the underlying computing components. As a result, such systems often suffer from low robustness, poor scalability, and limited adaptability to complex or ambiguous news content.

In particular, existing server systems do not provide a mechanism by which a processor systematically transforms raw article text into structured assertion information and numerical information using natural language processing, generates a precise prompt sentence tailored for a generative AI model, and integrates the model's output with results from search processing mechanisms in a unified reliability evaluation pipeline. The absence of this pipeline means that computing resources such as network interfaces, storage subsystems, and processing units are not orchestrated in a way that optimizes data flow, reduces redundant external queries, or improves the interpretability and traceability of reliability decisions. Furthermore, conventional architectures fail to exploit user-side and writer-side emotion signals as first-class technical inputs to the evaluation algorithm. Existing systems, if they consider emotion at all, typically treat it only as user-interface metadata rather than as structured data that can modulate the behavior of the scoring algorithms executed by the processor. Consequently, the computing system cannot dynamically adapt reliability computation based on behavioral information, emotional information, or text-based emotion analysis, and cannot reduce unnecessary processing or focus computational effort on suspicious or controversial content.

Additionally, prior techniques provide limited support for user-driven control over generative AI processing. Users typically cannot embed a custom analysis request sentence into a prompt sentence in a way that reliably constrains the behavior of the generative AI model within a server-side pipeline. This leads to non-deterministic or misaligned outputs from the model and prevents the server from providing deterministic, machine-actionable evaluation results. Accordingly, there is a need for a server-implemented system in which the processor is specifically configured to: (1) convert unstructured news text into structured assertion and numerical data via natural language processing; (2) generate and manage structured prompt sentences for a generative AI model; (3) coordinate calls to search processing mechanisms on an information communication network; (4) compute primary-source match indices and expert-agreement indices; (5) compute emotion indices from user behavior and/or writer-side emotion analysis; and (6) integrate these heterogeneous signals into a reliability evaluation value and an associated explanation. Such a configuration improves the operation of the computer system itself by organizing data flows, reducing redundant network traffic, optimizing the use of generative AI resources, and providing more stable and explainable outputs to user terminals.

The specific processing by the specific processing unit 290 of the data processing device 12 in Application Example 2 is realized by the following means.

The present invention provides a server comprising a processor and a memory storing instructions which, when executed by the processor, cause the processor to analyze, by using a natural language processing technique, a news text obtained from a user terminal to extract assertion information and numerical information included in the news text, to generate, based on the extracted assertion information and numerical information, a prompt sentence that instructs an information resource on an information communication network to be searched and a match with a primary source to be checked, to input the generated prompt sentence to a generative AI model and obtain, from the generative AI model, a degree of match with the primary source and explanatory information relating to the degree of match, to compare the assertion information extracted from the news text with an expert-knowledge information set and calculate a degree of agreement with an expert opinion, to calculate an emotion index relating to the news text based on behavioral information or emotional information of a user acquired from the user terminal and/or based on an emotion analysis result for the news text, to calculate, based on the degree of match obtained from the generative AI model, a result of comparison with the primary source, the degree of agreement with the expert opinion, and the emotion index, a reliability evaluation value indicating reliability of the news text and generate an evaluation result including the reliability evaluation value and the explanatory information, and to transmit the evaluation result to the user terminal. This enables the computing system to more efficiently and accurately evaluate news reliability by orchestrating natural language processing, generative AI inference, network-based search processing, expert-agreement computation, and emotion-based modulation within a unified server-side architecture, thereby improving the technical performance, scalability, and explainability of the computer-implemented reliability evaluation process.

The term “processor” refers to a hardware computation unit, such as a central processing unit or other programmable processing circuitry, that executes instructions to perform logical, arithmetic, control, and input/output operations required by the system.

The term “memory” refers to a hardware storage unit, such as a volatile or non-volatile storage device, that stores instructions and data for access and execution by the processor.

The term “user terminal” refers to an information processing device operated by a user, such as a personal computer, a mobile communication device, a tablet device, or a wearable device, that can transmit news text and related information to the server and receive evaluation results.

The term “news text” refers to an electronic text that describes events, topics, or issues intended for dissemination as news or informational content, including articles, reports, or posts provided via a network or other media.

The term “natural language processing technique” refers to a computational technique by which a computer analyzes, interprets, or generates human language text, including operations such as tokenization, part-of-speech tagging, parsing, named entity recognition, information extraction, and text classification.

The term “assertion information” refers to a set of textual segments or structured data that represent claims, propositions, or statements contained in the news text, including cause-and-effect statements, factual declarations, and opinion-like assertions extracted by natural language processing.

The term “numerical information” refers to data in the news text that express quantities, magnitudes, or numeric values, such as counts, percentages, dates, measurements, or monetary amounts, which are extracted and associated with corresponding assertions.

The term “prompt sentence” refers to a machine-readable instruction text generated by the processor and supplied to a generative AI model, the instruction text specifying tasks such as searching for information resources, checking consistency with a primary source, or generating explanatory information.

The term “generative AI model” refers to a machine learning model that, in response to an input including a prompt sentence, generates output text or structured data based on learned statistical patterns of language, and is capable of providing analyses, explanations, or evaluations relating to the input.

The term “information communication network” refers to a communication infrastructure that interconnects information resources, computers, and terminals, such as a packet-switched data network including the Internet or an equivalent digital communication network.

The term “information resource” refers to an electronically accessible data source available via an information communication network, including databases, data repositories, document servers, web pages, and other storage entities that store text, numerical data, or metadata.

The term “primary source” refers to an information resource that is considered an original or authoritative source of data regarding a particular fact or event, such as an official record, a governmental publication, a research dataset, or an originator's announcement.

The term “degree of match” refers to a quantitative or qualitative index indicating how closely information in the news text corresponds to information contained in a primary source, as derived from comparison performed by the generative AI model or other computation.

The term “explanatory information” refers to text or structured data that describe reasons, grounds, or context for a computed degree of match, reliability evaluation value, or other intermediate or final assessment, and that are generated or assembled by the processor or the generative AI model.

The term “expert-knowledge information set” refers to a collection of information items, such as documents, statements, or records, that reflect knowledge, opinions, or evaluations of domain experts regarding specific topics, and that are stored in a machine-readable form for comparison with assertion information.

The term “expert opinion” refers to a view, conclusion, or recommendation expressed by a person or entity having specialized knowledge or experience in a particular technical or professional field, which is represented as text or structured data in the expert-knowledge information set.

The term “degree of agreement” refers to a quantitative or qualitative measure that indicates how closely assertion information in the news text aligns with expert opinion contained in the expert-knowledge information set, as computed by similarity or comparison algorithms.

The term “behavioral information” refers to data that describe how a user interacts with the user terminal or the news text, including but not limited to reading duration, scrolling behavior, input operations, or other observable interaction patterns detected by the terminal or server.

The term “emotional information” refers to data representing an estimated emotional state of a user, derived from signals such as facial expression, voice characteristics, physiological indicators, or interaction patterns, and encoded as one or more emotion categories or scores.

The term “emotion analysis result” refers to an output of an algorithm that analyzes text, audio, video, or other input to infer emotional attributes, such as sentiment polarity or specific emotions, associated with the news text or with a user.

The term “emotion index” refers to a value or set of values computed by the processor that summarize one or more emotional attributes related to the news text, the user, or the writer, and that are used as a parameter in calculating a reliability evaluation value.

The term “search query information” refers to structured data generated by the processor, including keywords, identifiers, or constraints, and transmitted to a search processing mechanism in order to retrieve relevant information resources from an information communication network.

The term “search processing mechanism” refers to a hardware and software configuration, such as a search server or search engine, that receives search query information and returns search results corresponding to public information sources or other indexed information resources.

The term “public information source” refers to an information resource that is accessible to the general public via an information communication network, including open databases, public web sites, online publications, and publicly available records.

The term “primary-source match index” refers to a computed numerical or categorical indicator expressing an aggregate degree of agreement between information in public information sources and the assertion information and numerical information extracted from the news text.

The term “reliability evaluation value” refers to a numerical value or categorized level that indicates an overall reliability of the news text, computed by the processor based on a combination of the degree of match with a primary source, the degree of agreement with expert opinion, and the emotion index.

The term “evaluation result” refers to an information package generated by the processor and transmitted to the user terminal, the information package including at least the reliability evaluation value and explanatory information, and optionally including intermediate indices or supporting details.

The term “analysis request sentence” refers to a text input by the user that specifies a desired analysis, evaluation focus, or question, and that is incorporated by the processor into the prompt sentence to control processing performed by the generative AI model.

The term “response content of the generative AI model” refers to the output generated by the generative AI model in response to a prompt sentence, including reliability-related information, explanations, or answers tailored according to the analysis request sentence.

In one embodiment, a server implements the claimed system as a network-connected computer including at least one processor, a main memory, a non-volatile storage device, a network interface controller, and an operating system such as a general-purpose server operating system. The server hosts an application stack including an application framework, a database management system such as a relational database, a search engine such as a full-text search server, and one or more machine learning runtimes such as a numerical computation framework and a deep learning library. The server communicates with one or more user terminals via an information communication network.

The user operates a user terminal that may be a personal computer, a smart phone, a tablet device, or a wearable display device. The terminal includes a display, an input device such as a keyboard or touch screen, and optionally a camera and a microphone. The terminal executes a client application or a web browser that allows the user to select a news text, to input a URL or article identifier, and to input an analysis request sentence. The terminal transmits the selected news text, associated metadata, and the analysis request sentence to the server and receives an evaluation result from the server for display.

The server executes a program stored in the memory to analyze the news text and calculate a reliability evaluation value. The server uses a natural language processing library such as a statistical language processing toolkit or a neural language processing toolkit to parse the news text. The server converts the raw text into a sequence of tokens, performs part-of-speech tagging, dependency parsing, and named entity recognition, and extracts assertion information and numerical information. The server represents this extracted information in a structured data format in memory, for example, as records containing fields for subject terms, predicate terms, objects, numerical values, and temporal expressions. By imposing this structured representation, the server enables subsequent modules to operate on compact, machine-interpretable assertion vectors rather than on the entire raw text, which reduces memory usage and improves cache locality.

The server also maintains an expert-knowledge information set in a database. The server stores expert-knowledge information as documents with associated topic labels and vector representations. The server uses an embedding model, such as a multi-layer neural network trained to produce dense vector representations of sentences, to map both the assertion information from the news text and the expert-knowledge text into a common vector space. The server uses a similarity algorithm such as cosine similarity to calculate a degree of agreement between each assertion vector and each expert-knowledge vector. The server stores the similarity scores in a dedicated data structure, for example an array of floating-point values associated with assertion identifiers.

The server further accesses information resources on the information communication network, including public information sources that contain primary sources. The server uses a search processing mechanism, which may be implemented as a separate search server running a full-text indexing engine, to perform efficient retrieval. The server generates search query information by combining tokens corresponding to named entities, numerical values, and key terms extracted from the assertion information. The server sends the search query information to the search processing mechanism via a network interface and receives search results that include documents and metadata such as publication date and confidence scores. The server then computes for each assertion a primary-source match index as a function of the similarity between assertion vectors and vectors derived from the retrieved documents, and of the closeness between numerical values and dates in the assertion and in the documents. The server stores these indices in memory for use in reliability evaluation.

The server uses a generative AI model as a component in the evaluation pipeline. In one embodiment, the generative AI model is a transformer-based neural network comprising an input embedding layer, multiple self-attention layers, feedforward layers, and an output projection layer. The server accesses the generative AI model via an application programming interface, either locally if the model is deployed on a dedicated accelerator device such as a graphics processing unit, or remotely via a network to a model hosting service. The server provides to the generative AI model a prompt sentence that is constructed using the extracted assertion information, numerical information, and optionally an analysis request sentence input by the user.

The server generates the prompt sentence according to a predetermined template. For example, the server may generate:

“You are a fact-checking assistant. Check the reliability of the following article.
1. Identify which claims are supported by primary sources such as official databases or peer-reviewed publications.
2. Indicate any contradictions or missing primary sources.
3. Provide an overall reliability level: High, Medium, or Low.

Article claims: [list of extracted claims].

Full article: [full news text].”

In another example, when the user has input an analysis request sentence, the server may construct:

“User question: Please analyze whether this article about a new vaccine is consistent with official health authority data, and tell me how reliable it is.

You are a fact-checking assistant.
1. Compare the article's claims with primary sources such as official health authority databases.
2. Explain any discrepancies.
3. Provide an overall reliability level: High, Medium, or Low.

Article: [full news text].”

The server embeds the prompt sentence in a request to the generative AI model and receives from the generative AI model an output that includes textual explanations and a proposed reliability level. Internally, the generative AI model processes the prompt by encoding the input tokens into contextual embeddings, computing self-attention weights over the entire token sequence, and generating output token probabilities according to its trained parameters. The model has been trained by gradient-based optimization on large text corpora, minimizing a loss function such as cross-entropy between predicted and actual tokens. During generation in this system, the server configures inference hyperparameters such as decoding temperature, maximum length, and top-k or nucleus sampling thresholds to produce deterministic or constrained outputs suitable for machine parsing. By specifying a tightly structured prompt sentence and by using deterministic decoding parameters, the server constrains the model behavior and facilitates extraction of structured information (e.g., explicit labels “High”, “Medium”, or “Low”) from the model output, which improves machine interpretability and reduces error rates in downstream processing.

The server also calculates an emotion index related to the news text. In one embodiment, the terminal acquires behavioral information and emotional information from the user while the user is reading the article. The terminal uses a camera and microphone to capture facial expressions and voice signals, and uses a machine learning model deployed on the terminal, such as a convolutional neural network for facial emotion recognition and a recurrent or transformer network for speech emotion recognition, to classify emotional states into categories such as “anger”, “fear”, “trust”, or “neutral” and to estimate intensity scores. The terminal transmits these emotion labels and intensity values to the server as emotional information. In another embodiment, the server performs emotion analysis on the news text itself by using a sentiment classification model that has been trained to output scores for multiple emotions. The server then aggregates user-side and text-side emotion information into an emotion index. The server represents the emotion index as a vector of real-valued components corresponding to different emotion dimensions, which can be used to modulate the reliability evaluation algorithm.

The server integrates all computed indices-namely, the primary-source match index, the degree of agreement with expert opinions, the degree of match obtained from the generative AI model, and the emotion index-into a reliability evaluation value. The server uses a scoring algorithm that may be implemented as a linear or non-linear combination of these components. For example, the server may assign greater weight to the primary-source match index and the expert-agreement index, and use the generative AI model's proposed reliability level as a prior or tie-breaker in cases where signal values are ambiguous. The server may also use the emotion index to dynamically adjust the sensitivity of the scoring algorithm, for instance, by reducing the reliability evaluation value when emotion analysis indicates high anger or sensational tone, or by increasing it slightly when expert agreement and primary sources are strongly consistent while emotion analysis indicates neutral or analytical tone. The server stores the reliability evaluation value and associated explanatory information in the database and transmits them to the user terminal.

By structuring the data and computations in this manner, the server improves the operation of the computer system. The transformation of raw text into compact assertion records, expert-opinion vectors, and primary-source indices reduces the volume of data that must be transferred between modules and across the network. The use of a search processing mechanism with structured query information allows the server to avoid broad, unstructured search operations, thereby reducing network load and latency. The constrained prompt sentence design and deterministic inference parameters improve the reproducibility and parsability of outputs from the generative AI model, allowing the server to automate post-processing steps with fewer errors and fewer manual rules than in conventional systems. These factors together result in reduced computation time and memory consumption, increased throughput of news reliability evaluations, and increased accuracy and stability of the calculated reliability evaluation values.

In addition, the server uses the generative AI model in a non-conventional way by tightly coupling model inputs and outputs to intermediate data structures and deterministic algorithms. The server does not merely substitute the model for a human analyst; instead, the server treats the model as one component within a multi-stage pipeline. The server exploits the model's ability to reason over complex text while constraining the model with explicit prompt sentences and with pre-extracted assertion information. This architecture differs from human manual evaluation, which cannot systematically operate on vectorized assertion structures or systematically integrate primary-source indices and expert-agreement scores with model outputs. The server thereby implements a technical solution that is specific to the capabilities and limitations of machine processing.

The server also enables technical improvements in data management. The assertion information, numerical information, expert-knowledge information, primary-source indices, emotion indices, and reliability evaluation values are stored in normalized database tables with defined relationships. This structure allows efficient indexing and retrieval for later auditing, re-evaluation with updated models, or offline analysis. Because each evaluation is represented as a compact record composed of scalar values and vector identifiers, rather than full text alone, the server can perform batch computations and model re-training with less disk I/O and fewer cache misses, which improves computational efficiency and scalability.

The system can be implemented in multiple alternative configurations. In one alternative embodiment, the generative AI model is deployed on a local accelerator card connected to the server through a high-speed bus. The server then invokes the model by passing tensors representing tokenized prompt sentences directly to the accelerator runtime, reducing network latency and enabling lower inference cost per request. In another embodiment, the expert-knowledge information set is expanded to include domain-specific structured databases, and the server uses a graph database engine to model relationships between entities and facts; the server then computes expert-agreement indices using graph traversal algorithms and graph neural networks. In yet another embodiment, the emotion index incorporates physiological signals such as heart rate variability measured by a wearable device acting as a user terminal, and the server fuses these signals with facial and speech features in a multi-modal neural classifier.

The terminal uses the evaluation result not only to display a reliability score to the user but also to adjust user-interface elements in a technically constrained way. For example, the terminal may change the frequency of update requests or the granularity of data fetched from the server based on projected user interest inferred from the emotion index and the reliability evaluation value, thereby reducing unnecessary network traffic. The terminal may cache evaluation results for articles with stable high reliability evaluation values and only request incremental updates when underlying primary-source data change, which reduces computation load on the server.

The user, by interacting with the system and optionally entering an analysis request sentence that is embedded into the prompt sentence, effectively configures part of the computational pipeline. However, the user does not manually inspect primary sources or manually compute reliability scores. Instead, the user leverages the system's technical improvements in natural language understanding, model-guided evaluation, and structured data integration. The system therefore provides specific technical solutions to the technical problems of scalable, accurate, and explainable reliability evaluation of news texts in a networked computer environment.

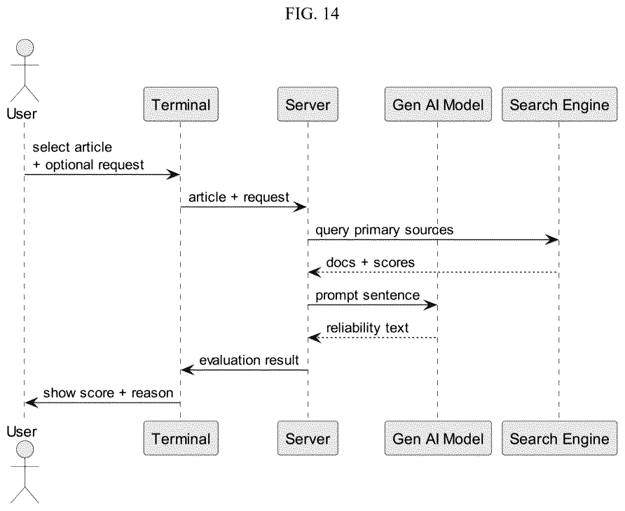

The following describes the processing flow using FIG. 14.

### Step 1

The user selects a news article to be evaluated.

The user operates a terminal and inputs a URL, an article identifier, or raw news text into a client application.

Input: User operation (URL, ID, or pasted text).

Output: Article selection data stored in the terminal (URL/ID/text and basic metadata).

### Step 2

The terminal acquires the news text and metadata.

The terminal, when a URL or ID is provided, sends an HTTP request to a content server or internal cache and downloads the corresponding news text; when raw text is provided, the terminal reads it directly from the input field. The terminal attaches metadata such as source identifier, timestamp, and language code.

Input: Article selection data (URL/ID/text).

Output: A structured article payload containing article text and metadata in the terminal's memory.

### Step 3

The terminal acquires an analysis request sentence from the user.

The user optionally types a free-form analysis request sentence such as “Please analyze whether this article about a new vaccine is consistent with official health authority data, and tell me how reliable it is.” The terminal stores this sentence and associates it with the article payload.

Input: User-typed Analysis Request Sentence.

Output: Article payload augmented with an analysis request sentence.

### Step 4

The terminal sends the article payload to the server.

The terminal constructs a network message, for example an HTTP POST request to a server endpoint, and includes the article text, metadata, and analysis request sentence as a JSON body. The terminal then transmits this message via the network interface.

Input: Augmented article payload in the terminal.

Output: Network request carrying article text, metadata, and analysis request sentence to the server.

### Step 5

The server receives and validates the article payload.

The server parses the incoming message, verifies that required fields such as article text and source identifier are present, checks character encoding (e.g., UTF-8), and assigns a unique evaluation identifier. The server stores the raw article and metadata in persistent storage such as a relational database.

Input: Network request from the terminal.

Output: Stored article record indexed by an evaluation identifier in the server's storage.

### Step 6

The server normalizes and segments the news text.

The server reads the stored article text into memory, removes control characters, normalizes whitespace, and converts the text to a canonical encoding. The server uses a natural language processing library to segment the text into sentences and tokens.

Input: Raw article text from storage.

Output: A sequence of sentences and tokens representing the normalized article text.

### Step 7

The server extracts assertion information and numerical information.

The server applies part-of-speech tagging and dependency parsing to the tokenized sentences and identifies clauses that contain factual claims or propositions. The server extracts subject terms, predicates, objects, and associated numerical values (counts, percentages, dates, amounts) and stores them as structured assertion records.

Input: Tokenized and parsed sentences.

Output: A set of assertion records and numerical information objects representing claims in the article.

### Step 8

The server generates search query information for primary-source retrieval.

The server selects key tokens from the assertion records, such as named entities and numerical values, and constructs search query strings and parameter objects suitable for a search engine or external API. The server may form queries like “country X 50,000 infection cases date Y official statistics”.

Input: Assertion records and numerical information.

Output: Structured search query information corresponding to each assertion.

### Step 9

The server searches public information sources and primary sources.

The server submits the search query information to a search processing mechanism, such as a search engine or external fact-checking API, via the network interface. The server receives search results including documents, snippets, and metadata. The server parses the results and maps them back to corresponding assertions.

Input: Search query information.

Output: Retrieved document sets and metadata associated with each assertion.

### Step 10

The server computes primary-source match indices.

The server compares the content and numerical values in the retrieved documents with the assertion records using similarity measures (e.g., cosine similarity on text embeddings and numeric difference thresholds). The server calculates a primary-source match index for each assertion and aggregates them into an overall primary-source score.

Input: Assertion records, numerical information, and retrieved document sets.

Output: Primary-source match indices per assertion and an overall primary-source score.

### Step 11

The server loads and prepares an expert-knowledge information set.

The server queries a database storing expert documents and commentary relevant to the article's topics. The server retrieves these expert texts and converts them into vector representations using an embedding model running on a machine learning framework.

Input: Topic identifiers or keywords derived from the assertion records.

Output: Expert-knowledge text fragments and corresponding expert-opinion vectors in memory.

### Step 12

The server compares assertion information with expert opinions.

The server encodes assertion texts into vectors using the same embedding model and computes similarity scores between assertion vectors and expert-opinion vectors. The server identifies, for each assertion, expert texts with the highest similarity scores and classifies agreement levels (e.g., aligned, partially aligned, contradicted).

Input: Assertion vectors and expert-opinion vectors.

Output: Similarity scores and a degree of agreement with expert opinions for each assertion, plus an aggregated expert-agreement index.

### Step 13

The server performs emotion analysis related to the article.

The server optionally receives emotional information from the terminal, such as emotion labels and intensities derived from user behavior. The server may also apply a sentiment or emotion classifier to the news text to infer writer-side emotional tone. The server then combines these signals into a numerical emotion index vector.

Input: User emotional information from the terminal and/or sentiment scores computed from the news text.

Output: An emotion index representing emotional attributes relevant to the article.

### Step 14

The server constructs a structured prompt sentence for the generative AI model.

The server uses the assertion records, numerical information, and the analysis request sentence (if provided) to fill a template that specifies tasks for the generative AI model. The server assembles a prompt sentence such as:

“You are a fact-checking assistant. Check the reliability of the following article.
1. Identify which claims are supported by primary sources such as official databases or peer-reviewed publications.
2. Indicate any contradictions or missing primary sources.
3. Provide an overall reliability level: High, Medium, or Low.

Article claims: [list of extracted claims].

Full article: [full news text].”

Input: Assertion records, numerical information, full article text, and analysis request sentence.

Output: A text prompt sentence formatted for the generative AI model.

### Step 15

The server sends the prompt sentence to the generative AI model and receives a response. The server submits the prompt sentence to a generative AI model via an API, specifying model parameters such as decoding temperature and maximum length. The generative AI model returns a textual response that includes a proposed reliability level and explanatory reasoning. The server parses the response to extract clearly delimited outputs such as “High”, “Medium”, or “Low” labels and rationale text.

Input: Prompt sentence.

Output: Parsed generative AI model outputs including a reliability suggestion and explanatory information.

### Step 16

The server calculates a reliability evaluation value.

The server combines the primary-source match indices, the expert-agreement index, the generative AI model's reliability suggestion, and the emotion index. The server applies a scoring algorithm, for example a weighted sum and non-linear transformation, to compute a numerical reliability evaluation value and a corresponding categorical level.

Input: Primary-source scores, expert-agreement indices, generative AI model outputs, and emotion index.

Output: A reliability evaluation value and a reliability level label for the article.

### Step 17

The server assembles an evaluation result including explanations.

The server composes an evaluation result object that contains the reliability evaluation value, the reliability level label, the primary reasons (e.g., strong primary-source agreement, strong expert alignment, or detected contradictions), and selected explanatory text from the generative AI model. The server stores this result in persistent storage associated with the evaluation identifier.

Input: Reliability evaluation value, reliability level, indices, and explanatory information.

Output: A structured evaluation result object ready for transmission to the terminal.

### Step 18

The server transmits the evaluation result to the terminal.

The server formats the evaluation result as a response payload, such as a JSON message, and sends it back to the terminal over the network interface using an appropriate communication protocol.

Input: Evaluation result object.

Output: Network response containing the evaluation result delivered to the terminal.

### Step 19

The terminal receives and displays the evaluation result.

The terminal parses the response payload and updates the user interface to show the reliability evaluation value, the reliability level, and key explanations. The terminal may display color indicators, numerical gauges, and textual summaries adjacent to the news text so that the user can interpret the reliability while reading.

Input: Network response from the server.

Output: Visual presentation of the reliability evaluation and explanations on the terminal display.

### Step 20

The user reviews the evaluation and optionally provides feedback.

The user observes the displayed reliability level and explanatory information and decides whether to trust or question the article. The user may provide feedback, such as “agree” or “disagree” with the evaluation, which the terminal sends back to the server for potential future adjustment of parameters or models.

Input: Displayed evaluation result and user perception.

Output: Optional user feedback data transmitted from the terminal to the server.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

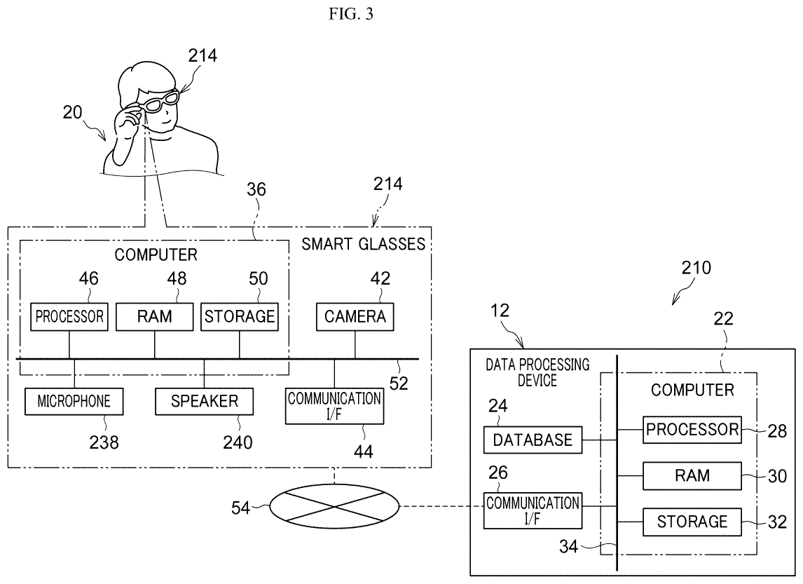

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

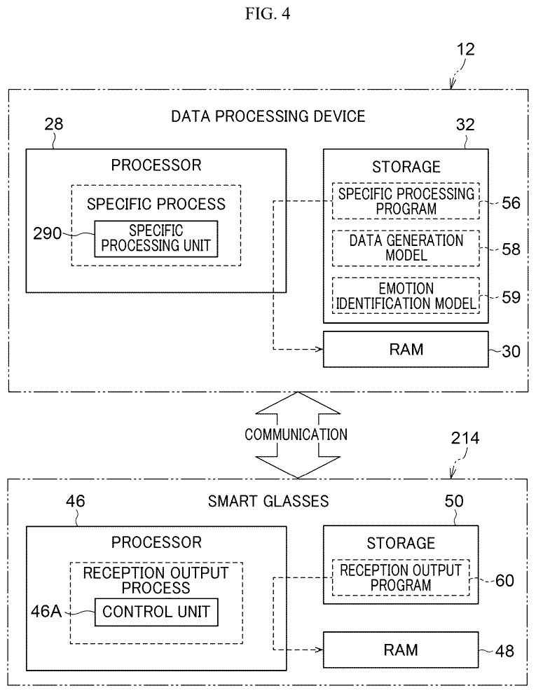

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

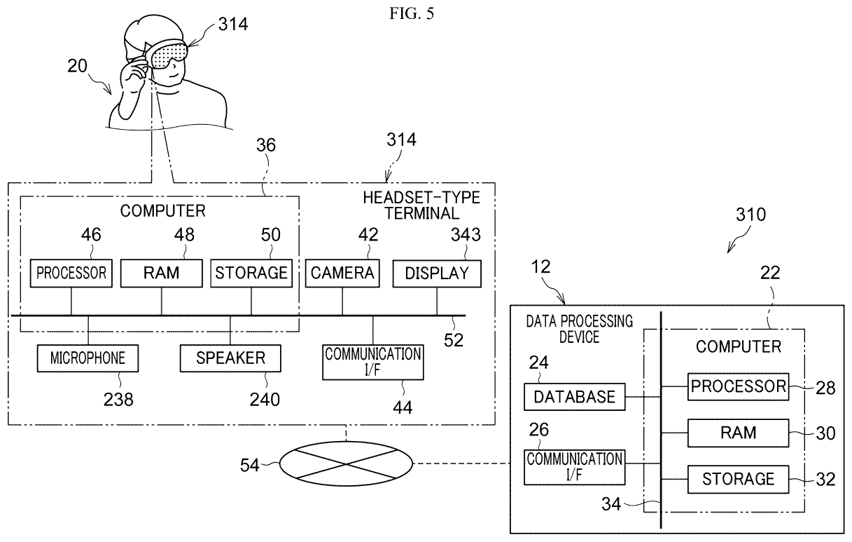

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

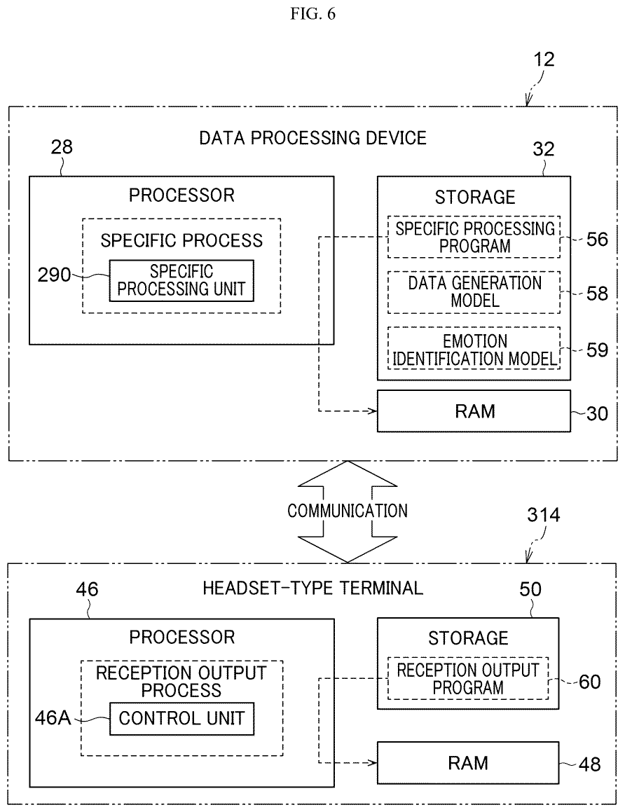

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

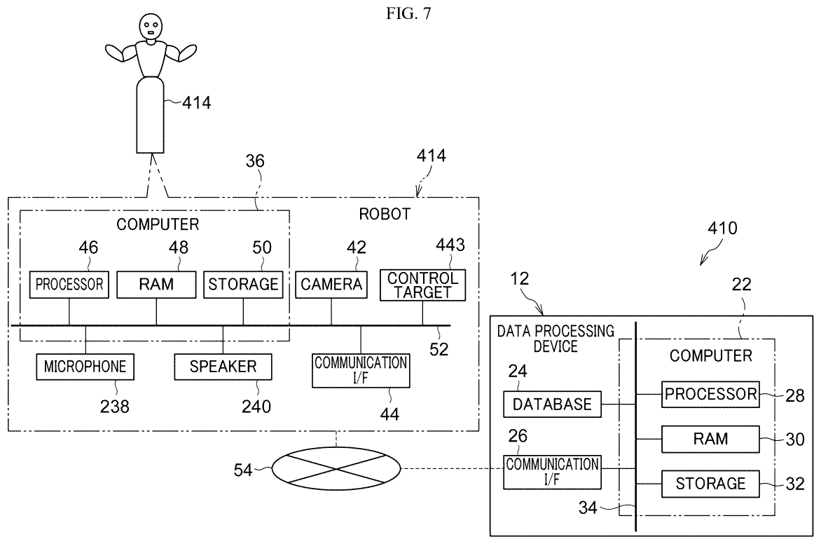

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

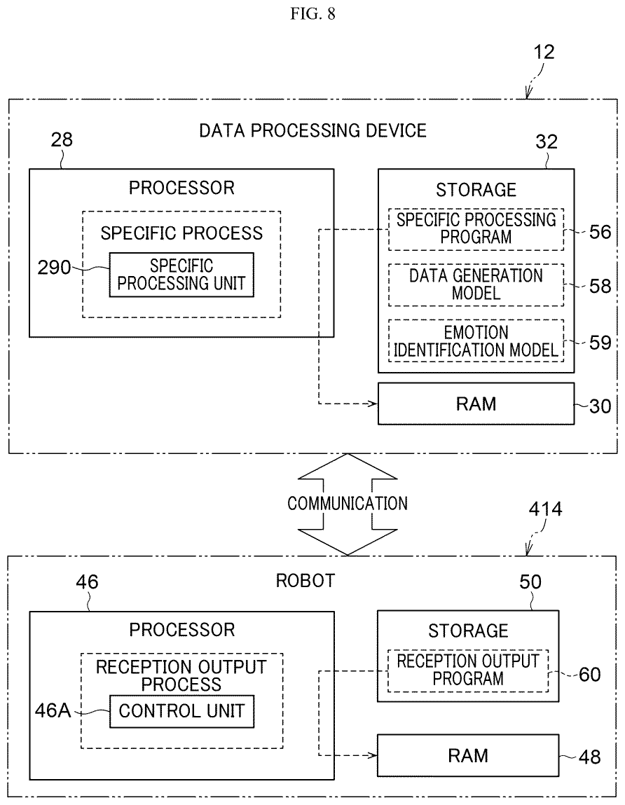

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

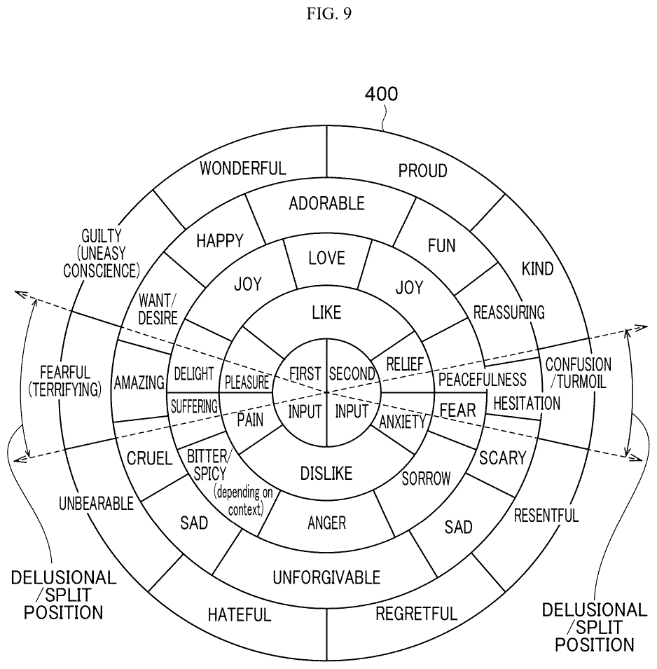

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

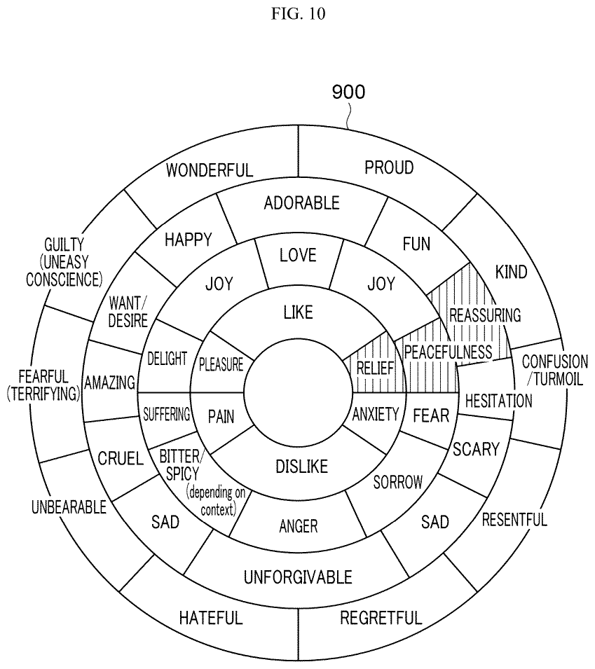

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire text of a news article, and
apply natural language processing to the text of the news article to perform lexical segmentation, syntactic analysis, and semantic analysis, extract factual information and numerical information from the text of the news article, and generate structured data representing the factual information and the numerical information, and
generate, based on the structured data, search terms including time information, subject information, and entity information, transmit a search request including the search terms to an external information providing apparatus via an information network, and acquire document information of primary-source candidates and text information corresponding to the document information from a public information source, and
perform feature extraction on the text of the news article and on the text information of the primary-source candidates, generate vector representations, calculate text similarity between each piece of the factual information in the text of the news article and each of the primary-source candidates by using a similarity calculation algorithm, and determine a support degree for each piece of the factual information based on the text similarity, and
calculate a reliability index for the news article as a whole based on the support degree for each piece of the factual information, generate evaluation intermediate data including the reliability index and the support degree for each piece of the factual information, generate a prompt sentence that instructs generation of an explanatory text regarding a degree of correspondence with the primary-source candidates, and input the prompt sentence and the evaluation intermediate data to a generative information processing model to acquire reliability evaluation explanation information from the generative information processing model, and
generate evaluation result data including the reliability index, the support degree for each piece of the factual information, the document information of the primary-source candidates, and the reliability evaluation explanation information, and transmit the evaluation result data to a user terminal.

### Supplementary 2

The system according to supplementary 1,
wherein the processor is configured to
assign, for each piece of the factual information and the numerical information in the text of the news article, one of a plurality of support categories including strong support, partial support, and no support based on the text similarity, calculate the reliability index by using a count and weighting of the factual information belonging to each of the support categories, and include the support categories and the document information of the primary-source candidates in the evaluation result data.

### Supplementary 3

The system according to supplementary 1,
wherein the processor is configured to
provide, in the prompt sentence to be input to the generative information processing model, structured data including the factual information extracted from the text of the news article, the text similarity, the text information of the primary-source candidates, and the reliability index, and instruct the generative information processing model to generate an explanatory text including reasons for determination of a support status for each piece of the factual information and a summary explanation regarding reliability of the news article as a whole.

### Application Example 1

### Supplementary 1

A system comprising a processor,
wherein the processor is configured to
acquire a news article text, and
perform text normalization and sentence segmentation on the acquired news article text and analyze the news article text on a word level and a sentence level by natural language processing, and
extract, based on an analysis result, entity information and important phrase information and generate search terms constituting search queries to information storage apparatuses of document information on an information network, and
acquire, based on the search terms, document information corresponding to primary source candidates from a plurality of types of information storage apparatuses of document information on the information network, and
extract candidate sentences from the news article text and identify, from the candidate sentences, assertion sentences including factual description or numerical description, and generate, based on evaluation target information including the news article text, the assertion sentences, the document information, and expert opinion information, a prompt sentence for evaluating a degree of match between each assertion sentence and the primary source candidates and a degree of consistency between the assertion sentences and the expert opinion information, and
input the prompt sentence to a generative artificial intelligence model and obtain evaluation result information including information on a support degree, a partial support degree, and a non-support degree for each assertion sentence and composite reliability information for the news article as a whole, and
calculate, based on the evaluation result information and the document information, a reliability score of the news article as a numerical index and generate a reliability category and warning information according to the reliability score, and
generate display data by including the reliability score, the reliability category, and the warning information and transmit the display data to a terminal device for presentation to a user on the terminal device.

### Supplementary 2

The system according to supplementary 1,
wherein the processor is configured to
include, in the prompt sentence input to the generative artificial intelligence model, a plurality of assertion sentences identified from the news article text, title information and summary information of the primary source candidates associated with the assertion sentences, and expert opinion information related to the assertion sentences in a structured format, and include, in the prompt sentence, evaluation instruction information that instructs the generative artificial intelligence model to output, for each assertion sentence, a support degree category and a basis explanation and to output a reliability score for the news article as a whole on a numerical scale within a predetermined range.

### Supplementary 3

The system according to supplementary 1,
wherein the processor is configured to
include, in the display data, display control information for causing, when the reliability score does not satisfy a predetermined threshold condition, the terminal device to perform emphasized display of an alert message and the reliability score with respect to the news article.

### Example 2

### Supplementary 1

A system comprising a processor,
wherein the processor is configured to
acquire input information,
analyze the input information by using a natural language processing program to perform segmentation into linguistic units and assignment of parts of speech, and extract important terms,
generate a first prompt sentence based on the extracted important terms, input the first prompt sentence into a generative AI model, obtain related terms from the generative AI model, and generate an expanded search term group including the important terms and the related terms, search information sources on an information communication network by using the expanded search term group, and acquire, as search results, a plurality of pieces of external information, perform similarity calculation between the input information and the external information, assign reliability weights based on attributes of information providers of the external information, and calculate a reliability evaluation value for the input information, generate a second prompt sentence for generating an explanation text regarding reliability of the input information based on the reliability evaluation value and the external information, input the second prompt sentence into the generative AI model, and obtain a reliability explanation text from the generative AI model, and
output the reliability evaluation value and the reliability explanation text to a terminal device.

### Supplementary 2

The system according to supplementary 1,
wherein the processor is configured to
cause the natural language processing program to extract name expressions and term expressions from the input information, and include extraction results in the first prompt sentence for the generative AI model.

### Supplementary 3

The system according to supplementary 1,
wherein the processor is configured to
use, in the calculation of the reliability evaluation value, determination information regarding a relationship between the input information and the external information, the determination information being obtained from the generative AI model.

### Application Example 2

### Supplementary 1

A system comprising a processor,
wherein the processor is configured to
analyze, by using a natural language processing technique, a news text obtained from a user terminal to extract assertion information and numerical information included in the news text, generate, based on the extracted assertion information and numerical information, a prompt sentence that instructs an information resource on an information communication network to be searched and a match with a primary source to be checked,
input the generated prompt sentence to a generative AI model and obtain, from the generative AI model, a degree of match with the primary source and explanatory information relating to the degree of match,
compare the assertion information extracted from the news text with an expert-knowledge information set and calculate a degree of agreement with an expert opinion,
calculate an emotion index relating to the news text based on behavioral information or emotional information of a user acquired from the user terminal and/or based on an emotion analysis result for the news text,
calculate, based on the degree of match obtained from the generative AI model, a result of comparison with the primary source, the degree of agreement with the expert opinion, and the emotion index, a reliability evaluation value indicating reliability of the news text, and generate an evaluation result including the reliability evaluation value and the explanatory information, and
transmit the evaluation result to the user terminal.

### Supplementary 2

The system according to supplementary 1,
wherein the processor is configured to
generate search query information by using the assertion information and the numerical information extracted from the news text as input, transmit the search query information to a search processing mechanism to search public information sources on the information communication network, acquire contents of the public information sources, calculate, based on a degree of agreement between the acquired contents and the assertion information and the numerical information, a primary-source match index, and use the primary-source match index in calculating the reliability evaluation value.

### Supplementary 3

The system according to supplementary 1,
wherein the processor is configured to
include, in the prompt sentence, an analysis request sentence input by the user, control an evaluation content to be executed by the generative AI model according to the analysis request sentence, and include, in the evaluation result, a response content of the generative AI model reflecting the analysis request sentence.

What is claimed is:

1. A system comprising:
circuitry configured to:
receive, via a communication interface coupled to a packet-switched network, text data from a terminal device;
extract, by applying a natural language processing model to the text data, structured feature data representing a plurality of factual assertions contained in the text data;
generate search query data based on the structured feature data and transmit the search query data to an external information source via the packet-switched network to acquire reference document data;
compute, based on vector representations of the structured feature data and the reference document data, similarity scores between each of the plurality of factual assertions and the reference document data;
generate, based on the similarity scores, a reliability evaluation value for the text data;
generate a prompt including the reliability evaluation value and the structured feature data, input the prompt to a generative neural network model, and acquire explanatory output data from the generative neural network model; and
transmit evaluation result data including the reliability evaluation value and the explanatory output data to the terminal device via the communication interface.

2. The system according to claim 1, wherein the circuitry is further configured to apply the natural language processing model to perform tokenization, part-of-speech tagging, and dependency parsing on the text data, and to identify named entities within the text data.

3. The system according to claim 2, wherein the circuitry is further configured to extract, from the text data, numerical information associated with respective factual assertions and normalize the numerical information into standardized numeric representations associated with corresponding entity identifiers and temporal expressions.

4. The system according to claim 3, wherein the circuitry is further configured to filter candidate sentences from the text data by applying syntactic and semantic criteria to identify assertion sentences containing at least one quantifiable predicate and one named entity of a predetermined category.

5. The system according to claim 4, wherein the text data comprises a news article, and wherein the circuitry is further configured to discard clauses marked as subjective or hypothetical based on lexical cues and dependency patterns.

6. The system according to claim 1, wherein the circuitry is further configured to generate the vector representations by applying a transformer-based sentence embedding model to the structured feature data and to the reference document data.

7. The system according to claim 6, wherein the circuitry is further configured to compute cosine similarity between the vector representations and additionally compute a token-level overlap measure, and to combine the cosine similarity and the token-level overlap measure in a weighted formula to obtain the similarity scores.

8. The system according to claim 7, wherein the transformer-based sentence embedding model comprises a transformer encoder trained using contrastive learning on pairs of semantically similar and dissimilar sentences, the training minimizing a cosine similarity loss.

9. The system according to claim 1, wherein the circuitry is further configured to assign, for each factual assertion, a support category selected from a plurality of support categories based on the similarity scores and predefined threshold values.

10. The system according to claim 9, wherein the plurality of support categories comprise strong support, partial support, and no support, and wherein the circuitry is further configured to calculate the reliability evaluation value by aggregating support categories weighted by importance values associated with respective factual assertions.

11. The system according to claim 10, wherein the circuitry is further configured to apply a penalty term proportional to a count of unsupported factual assertions having importance values above a predetermined importance threshold.

12. The system according to claim 1, wherein the circuitry is further configured to generate the search query data by selecting entity information, temporal expressions, and subject phrases from the structured feature data, applying lemmatization, and removing stop words.

13. The system according to claim 12, wherein the circuitry is further configured to perform deduplication of the reference document data by comparing document identifiers and computing title similarity scores.

14. The system according to claim 1, wherein the circuitry is further configured to compare the structured feature data with an expert-knowledge information set stored in a database accessible via the packet-switched network, and to calculate a degree of agreement with expert opinion data based on similarity between assertion vectors and expert-opinion vectors.

15. The system according to claim 14, wherein the circuitry is further configured to retrieve the expert opinion data by performing a nearest-neighbor search in an embedding space using an approximate nearest neighbor index structure.

16. The system according to claim 1, wherein the evaluation result data further includes display control information that causes the terminal device to perform emphasized display of an alert message when the reliability evaluation value does not satisfy a predetermined threshold condition.

17. The system according to claim 16, wherein the circuitry is further configured to calculate an emotion index based on at least one of behavioral information acquired from the terminal device or a sentiment analysis result for the text data, and to adjust the reliability evaluation value based on the emotion index.

18. A system comprising:
circuitry configured to:
receive, via a communication interface coupled to a packet-switched network, text data from a terminal device, and apply a transformer-based natural language processing model to perform tokenization, part-of-speech tagging, dependency parsing, and named entity recognition on the text data to extract assertion records each including a subject field, a predicate field, an object field, and a normalized numerical value field;
generate search query data by combining entity information, temporal expressions, and subject phrases extracted from the assertion records, transmit the search query data to a plurality of external information sources via the packet-switched network, and acquire reference document data including titles, abstracts, and source identifiers;
compute, by applying a sentence embedding model to generate dense vector representations of the assertion records and the reference document data, cosine similarity scores and token-level overlap measures between each assertion record and each reference document, and combine the cosine similarity scores and the token-level overlap measures in a weighted formula;
assign, for each assertion record, a support category selected from strong support, partial support, and no support based on the combined scores and predefined threshold values, and calculate a reliability evaluation value by aggregating the support categories weighted by importance values;
generate a structured prompt sentence including the reliability evaluation value, per-assertion support categories, similarity scores, and excerpts from the reference document data, input the structured prompt sentence to a generative neural network model comprising a transformer architecture with self-attention layers, and acquire reliability evaluation explanation information; and
transmit evaluation result data including the reliability evaluation value, the support categories, the reference document data identifiers, and the reliability evaluation explanation information to the terminal device via the communication interface.

19. The system according to claim 18, wherein the circuitry is further configured to compare the assertion records with an expert-knowledge information set by computing similarity between assertion vectors and expert-opinion vectors, and to incorporate a degree of agreement with expert opinion into the reliability evaluation value.

20. A method performed by circuitry of a server coupled to a packet-switched network via a communication interface, the method comprising:
receiving, via the communication interface, text data from a terminal device;
extracting, by applying a natural language processing model to the text data, structured feature data representing a plurality of factual assertions contained in the text data;
generating search query data based on the structured feature data and transmitting the search query data to an external information source via the packet-switched network to acquire reference document data;
computing, based on vector representations of the structured feature data and the reference document data, similarity scores between each of the plurality of factual assertions and the reference document data;
generating, based on the similarity scores, a reliability evaluation value for the text data;
generating a prompt including the reliability evaluation value and the structured feature data, inputting the prompt to a generative neural network model, and acquiring explanatory output data from the generative neural network model; and
transmitting evaluation result data including the reliability evaluation value and the explanatory output data to the terminal device via the communication interface.
